(19) United States
(12) Patent Application Publication
(10) Pub. No.: US 2026/0036854 A1
(43) Pub. Date: Feb. 5, 2026

(54) DISPLAY SUBSTRATE AND DISPLAY DEVICE

(71) Applicants: Beijing BOE Optoelectronics Technology Co., Ltd., Beijing (CN); BOE Technology Group Co., Ltd., Beijing (CN)

(72) Inventors: Qi DENG, Beijing (CN); Yong ZHANG, Beijing (CN); Zhichao YANG, Beijing (CN); Lingfang NIE, Beijing (CN); Zanwu GUO, Beijing (CN); Desheng WANG, Beijing (CN); Qiuyang ZHANG, Beijing (CN)

(21) Appl. No.: 18/995,282

(22) PCT Filed: May 14, 2024
(86) PCT No.: PCT/CN2024/093224

§ 371 Date: Jan. 16, 2025

(30) Foreign Application Priority Data
Jun. 21, 2023 (CN) 202310747749.1

(51) Int. Cl. G02F 1/1362

(52) U.S. Cl. CPC G02F 1/13629

(57) ABSTRACT

A display substrate and a display device. The display substrate includes: a first base substrate, including a display region, a first peripheral region; a signal line group, including signal lines. The signal lines includes first and second signal lines. The signal line group includes a first region and a second region arranged in an extension direction of the signal line group. The number of signal lines in the first region is greater than the number of signal lines in the second region. In the first region, orthographic projections of the first signal lines overlaps orthographic projections of the second signal lines on the first base substrate. In the second region, the first and second signal lines are alternately arranged. The first region includes sub-regions.

### CROSS-REFERENCE TO RELATED APPLICATIONS

This application is a National Stage of International Application No. PCT/CN2024/093224, filed on May 14, 2024, which claims priority to Chinese Patent Application No. 202310747749.1, filed on Jun. 21, 2023, in the China National Intellectual Property Administration. The entire disclosure of the above applications is incorporated herein by reference.

### TECHNICAL FIELD

The disclosure herein relates the display technology field, especially to a display substrate and display device.

### BACKGROUND

With the continuous development and application of display technology, users have higher and higher requirements for the display effect of electronic display products.

The peripheral region of the display product usually needs to set up signal lines, and the signal lines on the left and right sides of the low-resolution product adopt a single-layer wiring or double-layer alternating wiring, but for the narrow-bezel products with a left and right bezel less than 1 millimeter (mm) and high resolution, the number of signal lines that need to be set on each bezel is large, and the left and right 1 mm bezels cannot meet the space of single-layer wiring or double-layer alternating wiring.

### SUMMARY

The embodiment of the disclosure provides a display substrate and a display device to save wiring space.

Some embodiments of the present disclosure provide a display substrate including:
a first base substrate including a display region and a peripheral region enclosing the display region; wherein the peripheral region includes first peripheral regions that is respectively arranged on two sides of the display region in a first direction;
at least one signal line group, located at least in the first peripheral regions and disposed on a side of the first base substrate, wherein the at least one signal line group includes a plurality of signal lines, and the plurality of signal lines include a plurality of first signal lines arranged along the first direction, and a plurality of second signal lines that are disposed in a layer different from a layer of the plurality of first signal lines and arranged along the first direction;
in the first periphery area, the at least one signal line group includes a first region and a second region arranged in an extension direction of the at least one signal line group; a quantity of signal lines included in the first region is greater than a quantity of signal lines included in the second region;
in the first region, an orthographic projection of the plurality of first signal lines on the first base substrate overlaps with an orthographic projection of the plurality of second signal lines on the first base substrate;
in the second region, the plurality of first signal lines and the plurality of second signal lines are alternately arranged along a first direction;
the first region includes a plurality of sub-regions arranged sequentially in the extension direction of the at least one signal line group; and
a distance between an edge, far away from the display region, of at least one of the plurality of sub-regions and the display region is less than a distance between an edge, far away from the display region, of at least one of rest of the plurality of sub-regions and the display region.

In some embodiments, the first region includes: a plurality of first sub-regions and at least one second sub-region; the second sub-region connects two adjacent first sub-regions;
in the first sub-regions, the signal lines extend along the second direction, and in the second sub-region, the signal lines extend along a third direction;
the second direction intersects with the first direction; and an angle a1 between the third direction and a direction from a first peripheral region corresponding to the second sub-region to the display region is greater than 0° and less than 90°.

In some embodiments, the display substrate further includes:
a plurality of scanning lines disposed on a side of the first base substrate, and extending from the display region to the first peripheral region; wherein the plurality of scanning lines are arranged along the second direction and extend along the first direction; one signal line in the at least one signal line group is electrically connected with one of the plurality of scanning lines at one end of the one signal line in an extension direction of the one signal line;
a quantity of signal lines included in the second sub-region is less a quantity signal lines included in a first sub-region that is connected with the second sub-region on a side far away from the second region.

In some embodiments, the quantity of signal lines included in the second sub-region is greater than or equal to a quantity of signal lines included in a first sub-region that is connected with the second sub-region on a side close to the second region.

In some embodiments, in the two first sub-regions connected by the second sub-region, a maximum width, in the first direction, of a first sub-region far away from the second region is greater than a maximum width, in the first direction, of a first sub-region close to the second region.

In some embodiments, in the two first sub-regions connected by the second sub-region, in the first sub-region far away from the second region, a first distance between a signal line closest to the display region at a junction of the first sub-region far away from the second region and the second sub-region, and the display region in the first direction is indicated as L1, and a second distance between a signal line closest to the display region at a junction of the first sub-region close to the second region and the second sub-region, and the display region in the first direction is indicated as L2;
a length of a signal line closest to the display region in the second sub-region in an extension direction of the signal line closest to the display region in the second sub-region is indicated as L3;
wherein L1, L2, and L3 satisfy:

$$L 2 < L 1 ; and$$

$$L 2 ⩾ L 1 - L 3 \times cos a 1.$$

In some embodiments, in the first sub-regions and the second sub-region, the signal line group includes a plurality of subgroups, and at least part of the subgroups include one first signal line and one second signal line with an orthographic projection of the one first signal line on the first base substrate overlapping an orthographic projection of the one second signal line; in the first sub-regions and the second sub-region, line widths of the plurality of subgroups are equal, and spacings between any two adjacent subgroups are equal;
in the two first sub-regions connected with the second sub-region, the first sub-region far away from the second region includes m subgroups, and the first sub-region close to the second region includes n subgroups, wherein m>n, and m and n are positive integers;
the line widths L4 of the subgroups, the spacings L5 between the any two adjacent subgroups, the first distance L1, and the second distance L2 satisfy:

$$[ m \times L 4 + ( m - 1 ) \times L 5 ] - [ n \times L 4 + ( n - 1 ) \times L 5 ] \leq L 1 - L 2.$$

In some embodiments, lengths of a plurality of signal lines included in the second sub-region in an extension direction of the plurality of signal lines included in the second sub-region are equal.

In some embodiments, edges of junctions of the second sub-region and the two adjacent first sub-regions extend along a fourth direction, and an angle a2 between the fourth direction and a direction from the display region to the first peripheral region corresponding to the second sub-region is greater than 0° and less than 90°.

In some embodiments, the angle a1 is greater than or equal to 30° and less than or equal to 60°, and the angle a2 is greater than or equal to 15° and less than or equal to 30°.

In some embodiments, the first region includes one second sub-region; the display region includes a first edge extending along the first direction; an extension line of the first edge is positioned on a side of the first region far away from the second region;
in the second direction, a third distance from a junction of a signal line closest to the display region in the second sub-region and the first sub-region far away from the second region to the first edge is indicated as L7; the third distance L7 and a width L8 of the display region in the second direction satisfy: L7=L8/3.

In some embodiments, the first region includes two second sub-regions; the display region includes a first edge extending along the first direction; an extension line of the first edge is positioned on a side of the first region far away from the second region;
in the second direction, in a second sub-region of the two second sub-regions far away from the second region, a fourth distance from a junction of a signal line closest to the display region and a first sub-region far away from the second region to the first edge is indicated as L9; in the second direction, in a second sub-region of the two second sub-regions close to the second region, a fifth distance from a junction of a signal line closest to the display region and the first sub-region far away from the second region to the first edge is indicated as L10;
the fourth distance L9 and the width L8 of the display region in the second direction satisfy: L9=L8/4; and
the fifth distance L10 and the width L8 of the display region in the second direction: L10=L8/2.

In some embodiments, the display substrate further includes:
a third signal line disposed on a side of the first base substrate and located in the peripheral region;
in the first direction, the third signal line in the first peripheral region is located on a side of the signal line group far away from the display region;
the third signal line includes a first part and a second part;
the second part is adjacent to at least the second sub-region and a first sub-region connected with the second sub-region on a side close to the second region;
in the first direction, a maximum width of the first part is less than a maximum width of the second part;
the second part includes a first sublayer and a second sublayer on a side of the first sublayer facing away from the first base substrate; and
in the first periphery area, spacings between the second part and different sub-regions of the signal line group are approximately equal.

In some embodiments, an orthographic projection of the second sublayer on the first base substrate is located within an orthographic projection of the first sublayer on the first base substrate.

In some embodiments, a pattern of an orthographic projection of the first sublayer on the first base substrate is grid-shaped.

In some embodiments, the first sublayer and the first signal lines are disposed in a same layer, and the second sublayer and the second signal lines are disposed in a same layer.

In some embodiments, the first region further includes a third sub-region, and the second region includes a fourth sub-region connected with the third sub-region; the third sub-region is connected with a first sub-region closest to the second region;
signal lines in the fourth sub-region extend along the second direction, at least a part of signal lines in the third sub-region includes a portion extending along a fifth direction, and an angle a3 between the fifth direction and a direction from the display region to the first peripheral region corresponding to the second sub-region is greater than 0° and less than 90°.

In some embodiments, a quantity of signal lines included in the third sub-region is less than a quantity of signal lines included in the first sub-region closest to the second region.

In some embodiments, a quantity of signal lines included in the fourth sub-region is less than or equal to the quantity of signal lines included in the third sub-region.

In some embodiments, a minimum width of the first sub-region closest to the second region in the first direction is less than a maximum width of the fourth sub-region in the first direction.

In some embodiments, a signal line far away from the display region in the first sub-region connected with the third sub-region and a signal line far away from the display region in the fourth sub-region are is located on a same straight line.

In some embodiments, in the first direction, a sixth distance from a junction of a signal line closest to the display region in the first sub-region closest to the second region and the third sub-region to the display region is indicated as L11, a seventh distance from a signal line closest to the display region in the fourth sub-region to the display region is indicated as L12, and a length of the signal line closest to the display region in the third sub-region in an extension direction of the signal line closest to the display region in the third sub-region is indicated as L13;
L11, L12, and L13 satisfy:

$$L 12 < L 11 ;$$

$$L 12 ⩾ L 11 - L 13 \times cos a 3.$$

In some embodiments, in the first sub-regions and the third sub-region, the signal line group includes a plurality of subgroups;
wherein in the fourth sub-region, the first signal lines have a first line width L14, the second signal lines have a second line width L15, and a distance between the first signal lines and the second signal lines is indicated as L16,
the first sub-region closest to the second region includes k subgroups, and the fourth sub-region includes e1 first signal lines and e2 second signal line; wherein e1, e2, k are positive integers, and e1+e2<2k;
e1, e2, k, L11, L12, L14, L15, L16, the first line width L14, and a spacing L5 between adjacent subgroups satisfy:

$$[ e 1 \times L 14 + e 2 \times L 15 + ( e 1 + e 2 - 1 ) \times L 16 ] - [ k \times L 4 + ( k - 1 ) \times L 5 ] \leq L 11 - L 12.$$

In some embodiments, the first region includes one second sub-region; the display region includes a first edge extending along the first direction; an extension line of the first edge is positioned on a side of the first region far away from the second region;
in the second direction, an eighth distance from a junction of a signal line closest to the display region in the third sub-region and the first sub-region to the first edge is indicated as L17; and
the eighth distance L17 and a width L8 of the display region in the second direction satisfy: L17=2×L8/3.

In some embodiments, the first region includes two second sub-regions; the display region includes a first edge extending along the first direction; an extension line of the first edge is positioned on a side of the first region far away from the second region;
in the second direction, an eighth distance from a junction of a signal line closest to the display region in the third sub-region and the first sub-region to the first edge is indicated as L17; the eighth distance L17 and a width L8 of the display region in the second direction satisfy: L17=3×L8/4.

In some embodiments, in a direction from the first peripheral region corresponding to the third sub-region to the display region:
a length, in an extension direction of the plurality of first signal lines, of the plurality of first signal lines included in the third sub-region gradually increases; and
a length, in an extension direction of the plurality of second signal lines, of the plurality of second signal lines included in the third sub-region gradually increases.

In some embodiments, an edge of a junction of the third sub-region and the first sub-region extends along the fifth direction, and an angle a4 between the fifth direction and a direction from the display region to the first peripheral region corresponding to the second sub-region is greater than 0° and less than 90°; and
an edge of a junction of the third sub-region and the fourth sub-region extends along a sixth direction, and an angle a5 between the sixth direction and a direction from the first peripheral region corresponding to the second sub-region to the display region is greater than 0° and less than 90°.

In some embodiments, the angle a3 is greater than or equal to 30° and less than or equal to 60°;
the angle a4 is greater than or equal to 15° and less than or equal to 30°; and
the angle a5 is greater than or equal to 5° and less than or equal to 15°.

In some embodiments, the display substrate further includes a third signal line, and the third signal line includes a second part; the second part is adjacent to the third sub-region and the fourth sub-region.

In some embodiments, the peripheral region further includes a second peripheral region on a side of the display region in the second direction;
the signal line group further includes a fifth sub-region and a sixth sub-region in the second peripheral region;
the fifth sub-region connects the sixth sub-region with the first region, signal lines in the fifth sub-region extend along the second direction, and an extension direction of signal lines in the sixth sub-region intersects with the second direction;
in the fifth sub-region, the orthographic projection of the plurality of first signal lines on the first base substrate overlaps with the orthotropic projection of the plurality of second signal lines on the first base substrate; and
in the sixth sub-region, the plurality of first signal lines and the plurality of second signal lines are alternately arranged along the first direction.

In some embodiments, the signal line group in the second peripheral region further includes a seventh sub-region connected with the sixth sub-region;
an extension direction of signal lines in the seventh sub-region intersects with the second direction, and the extension direction of the signal lines in the seventh sub-region intersects with the extension direction of the signal lines in the sixth sub-region;
in the seventh sub-region, the plurality of first signal lines and the plurality of second signal lines are alternately arranged along the first direction.

In some embodiments, an edge of a junction of the sixth sub-region and the fifth sub-region extends along a seventh direction, and an angle a6 between the seventh direction and a direction from the display region to the first peripheral region is greater than 0° and less than 90°;
an edge of a junction of the sixth sub-region and the seventh sub-region extends along an eighth direction, and an angle a7 between the eighth direction and the direction from the display region to the first peripheral region is greater than 0° and less than 90°.

In some embodiments, the seventh direction is parallel to the eighth direction; and
an angle a8 between an extension direction of at least part of the signal lines in the sixth sub-region and the first direction, the angles a6, and the angle a7 are all 45°.

In some embodiments, the display substrate includes two signal line groups, and the two signal line groups correspond to two first peripheral regions respectively; and
the display substrate includes a plurality of scanning lines, one of the two signal line groups is electrically connected with scanning lines in odd-numbered rows, and other group of the two signal line groups is electrically connected with scanning lines in even-numbered rows.

Some embodiments provide a display device, including:
the display substrate according to above embodiments;
an opposing substrate arranged oppositely to the display substrate, and
a liquid crystal layer between the display substrate and the opposing substrate.

In some embodiments, the display substrate includes a third signal line, and the third signal line includes a second part;
display device further includes:
a plurality of supporting portions between the display substrate and the opposing substrate;
an orthographic projection of the supporting portions on the first base substrate overlaps with an orthographic projection of the second part on the first base substrate.

In some embodiments, the display substrate includes a second peripheral region, and the second periphery region includes a bonding region;
the display substrate further includes a plurality of signal terminals disposed on a side of the first base substrate and located in the bonding region, and the signal line group is electrically connected with a part of the plurality of signal terminals;
the display device further includes a driver chip, and the driver chip is bonded to the plurality of signal terminals in the bonding region.

### BRIEF DESCRIPTION OF FIGURES

In order to more clearly illustrate the technical solutions in the embodiments of the present disclosure, the drawings required in the description of the embodiments will be briefly described below, and it is obvious that the drawings described below are only some embodiments of the present disclosure, and other drawings can be obtained according to these drawings without creative labor on the premise of those skilled in the art.

FIG. 1 is a structural schematic diagram of a display substrate provided by an embodiment of the present disclosure;

FIG. 2 is structural schematic diagram of another display substrate provided by an embodiment of the present disclosure;

FIG. 3 is a schematic diagram of enlarged region A in FIG. 2 provided by an embodiment of the present disclosure;

FIG. 4 is a cross-sectional view along BB′ in FIG. 3 provided by an embodiment of the present disclosure;

FIG. 5 is a structural schematic diagram of another display substrate provided by an embodiment of the present disclosure;

FIG. 6 is a structural schematic diagram of another display substrate provided by an embodiment of the present disclosure;

FIG. 7 is a structural schematic diagram of another display substrate provided by an embodiment of the present disclosure;

FIG. 8 is a structural schematic diagram of another display substrate provided by an embodiment of the present disclosure;

FIG. 9 is a schematic diagram of enlarged region C in FIG. 7 provided by an embodiment of the present disclosure;

FIG. 10 is a structural schematic diagram of another display substrate provided by an embodiment of the present disclosure;

FIG. 11 is a schematic diagram of enlarged region E in FIG. 1 provided by an embodiment of the present disclosure;

FIG. 12 is a structural schematic diagram of another display substrate provided by an embodiment of the present disclosure;

FIG. 13 is a schematic diagram of enlarged D area in FIG. 12 provided by an embodiment of the present disclosure;

FIG. 14 is a structural schematic diagram of a display device provided by an embodiment of the present disclosure;

FIG. 15 is a structural schematic diagram of another display device provided by an embodiment of the present disclosure;

FIG. 16 is a structural schematic diagram of another display device provided by an embodiment of the present disclosure.

### DETAILED DESCRIPTION

In order to make the purpose, technical solution and advantages of the embodiments of the present disclosure clearer, the technical solutions of the embodiments of the present disclosure will be clearly and completely described below in conjunction with the accompanying drawings of the embodiments of the present disclosure. Obviously, the embodiments described are some embodiments of the present disclosure, not all embodiments. And in the absence of conflict, the embodiments in the present disclosure and the features in the embodiments may be combined with each other. Based on the embodiments of the present disclosure described, all other embodiments obtained by a person skilled in the art without creative labor are within the scope of protection of the present disclosure.

Unless otherwise defined, the technical or scientific terms used in this disclosure shall have the ordinary meaning understood by persons with general skills in the field to which this disclosure belongs. The terms “first”, “second” and similar expressions used in this disclosure do not indicate any order, number or importance, but only to distinguish the different components. Words such as “include” or “comprise” mean that the element or object that precedes the word includes the element or object listed after the word and its equivalents, and does not exclude other elements or objects. Similar terms such as “connection” or “link” are not limited to physical or mechanical connections, but may include electrical connections, whether direct or indirect.

It should be noted that the dimensions and shapes of the figures in the drawings do not reflect the true proportions, and are intended to illustrate the contents of this disclosure. The same or similar designation at all times indicates the same or similar element or component with the same or similar function.

In the related art, for low-resolution display products, the signal lines of the peripheral regions on the left and right sides of the display region adopt the mode of single-layer wiring or double-layer alternating wiring, but for the narrow-bezel products with the left and right bezels less than 1 millimeter (mm) and high resolution, the number of signal lines that need to be set on each side of the bezel is larger, and the bezel of 1 mm on the left and right cannot provide sufficient wiring space for single-layer wiring or double-layer alternating wiring. If the plurality of signal lines on one side of the display region adopts the mode of double-layer overlapping wiring, that is, the orthographic projections of the signal lines located in different layers have overlapping areas, then it will cause the formation of parallel plate capacitance between the two layers of signal lines, according to the calculation formula of capacitance C=εS/d, ε is the dielectric constant of the medium between the two layers of signal lines, S is the overlapping area of the two layers of signal lines, d is the distance between the two layers of signal lines. It can be seen that the use of overlapping wiring will make the capacitance of the overlapping area of the orthographic projection of the signal line twice that of the single-layer wiring, which affects the charging rate of the pixels.

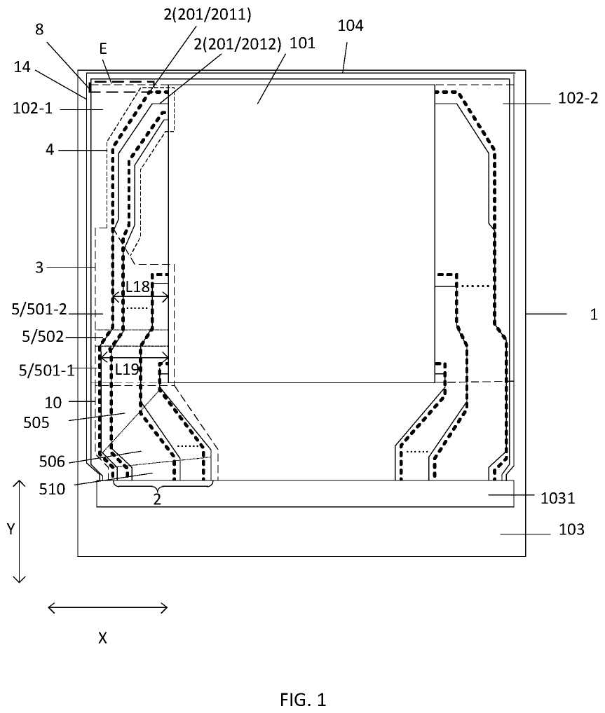

Some embodiments of the disclosure provide a display substrate, as shown in FIG. 1, and the display substrate includes:
a first base substrate 1 including a display region 101 and a peripheral region 102 enclosing the display region 101; the peripheral region 102 includes: the first peripheral regions 102-1, 102-2 on both sides of the display region 101 in the first direction X;
at least one signal line group 2 at least on a side of the first base substrate 1 in the first peripheral region 102-1, and including a plurality of signal lines 201; the plurality of signal lines 201 include: a plurality of first signal lines 2011 arranged along the first direction X, and a plurality of second signal lines 2012 located at different layers from the first signal lines 2011 and arranged along the first direction X. In the first peripheral region 102-1, the signal line group 2 includes a first region 3 and a second region 4 arranged in the extension direction of the signal line group 2. The number of signal lines included in the first region 3 is greater than the number of signal lines included in the second region 4. In the first region 3, the orthographic projection of the plurality of first signal lines 2011 on the first base substrate 1 overlaps with the orthographic projection of the plurality of second signal lines 2012 on the first base substrate 1. In the second region 4, a plurality of first signal lines 2011 and a plurality of second signal lines 2012 are alternately arranged along the second direction Y. The first region 3 includes a plurality of sub-regions 5 arranged sequentially in the extension direction of the signal line group 2. A distance L18 from the edge of at least one of the sub-regions 5 in the plurality of sub-regions 5 away from the edge of the display region 101 to the display region 101 is less than a distance L19 from the edge of at least one of the remaining sub-regions 5 in the plurality of sub-regions 5 away from the edge of the display region 101 to the display region 101.

It should be noted that the display region and display substrate include a plurality of sub-pixel units arranged in array along the first and second directions. The plurality of signal lines in the signal line group are configured to provide signals to the sub-pixel units in the display region. A signal line in the signal line group closest to the display region is electrically connected to the first row of sub-pixels in the second direction from the first region to the second region at one end of the extension direction of the signal line. A signal line in the signal line group furthest from the display region is electrically connected to the last row of sub-pixels in the second direction from the first region to the second region at one end of the extension direction of the signal line, so that the number of signal lines in the signal line group gradually decreases in the second direction from the first region to the second region.

In the display substrate provided by the embodiment of the present disclosure, in the first region where the number of signal lines is large, the orthographic projection of a plurality of first signal lines on the first base substrate and the orthographic projection of a plurality of second signal lines on the first base substrate overlap, that is, a plurality of signal lines included in the signal line group are overlapped and routed in the first region, so that the wiring space of the signal line can be saved, and the size of the first peripheral region in the first direction is avoided from being too large and is not conducive to realizing a narrow bezel. In the second region where the number of signal lines is small, a plurality of first signal lines and a plurality of second signal lines are alternately arranged along the first direction, that is, a plurality of first signal lines and a plurality of second signal lines included in the signal line group are alternately routed in the second region, and because the number of signal lines is reduced, the plurality of first signal lines and the plurality of second signal lines can be arranged alternately in the second region without increasing the width of the second peripheral region in the first direction, so as to avoid the complete overlap of signal lines and cause the capacitance to increase and affect the sub-pixel charging. Moreover, because the number of signal lines in the signal line group decreases in the second direction from the first region to the second region, the number of signal lines in the plurality of sub-regions included in the first region is not exactly the same, the number of signal lines included in at least one sub-region near the second region is less than the number of signal lines included in at least one sub-region far away from the second region, and the wiring space required for at least one sub-region near the second region is less than the wiring space required for at least one sub-region far away from the second region, and thus it can be set to the distance L18 between the edge of at least one sub-region away from the display region to the display region in the plurality of sub-regions is less than the distance L19 between the edge of at least one sub-region of the remaining sub-regions away from the display region to the display region in the plurality of sub-regions, that is, one of the sub-regions retracts towards the display region relative to the other sub-region, and the wiring space on the side of the sub-region away from the display region increases, which is conducive to setting other structures.

In some embodiments, as shown in FIG. 1, the peripheral region 102 further includes a second peripheral region 103 located on a side of the display region 101 in the second direction Y.

The signal line group 2 further includes: a third region 10 located in the second peripheral region 103. The third region 10 is connected with the first region 3, i.e. the second region 4 is located on a side of the first region 3 away from the second peripheral region 103.

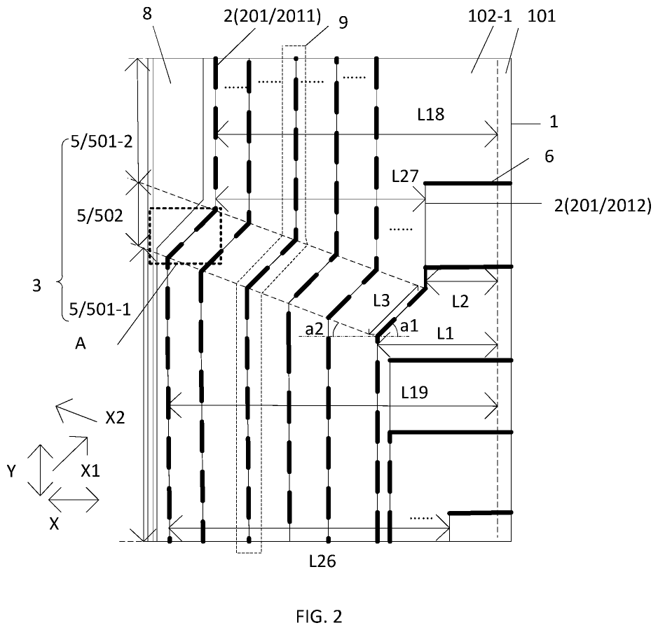

In some embodiments, as shown in FIG. 2, the display substrate further includes:
a plurality of scanning lines 6 located on one side of the first base substrate 1, and extending from the display region 101 to the first peripheral region 102-1; the plurality of scanning lines 6 are arranged along the second direction Y and extend along the first direction X; a signal line 201 in the signal line group 2 is electrically connected with one of the scanning lines 6 in the plurality of scanning lines 6 at one end in the extension direction of the signal line 201.

In some embodiments, as shown in FIG. 1, the second peripheral region 103 includes a bonding region 1031. The bonding region includes a plurality of signal terminals (not shown) arranged on one side of the first base substrate 1. The signal line group is electrically connected with the signal terminals of the bonding region 1031.

In the specific embodiment, the signal terminals of the bonding region is bonded with the driver chip. The driver chip provides a scanning signal to the scanning lines through the signal line group.

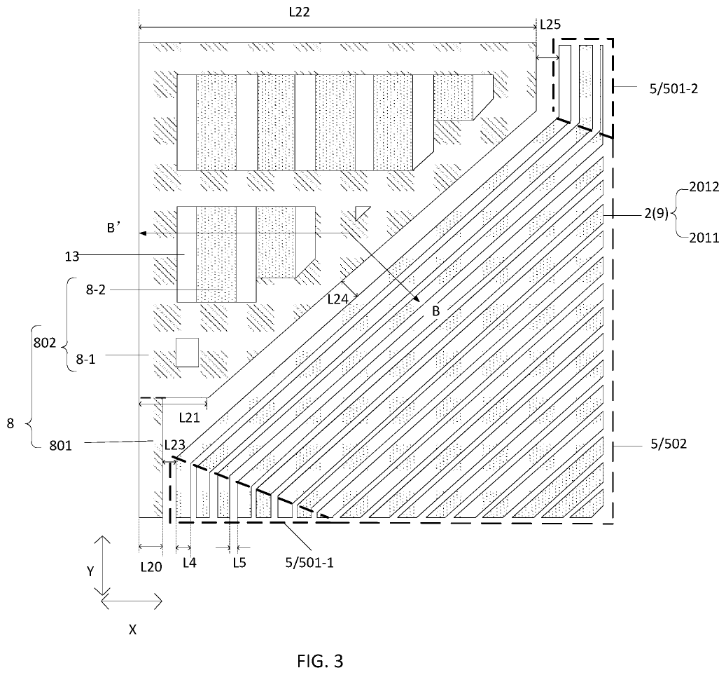

In some embodiments, as shown in FIG. 2 and FIG. 3, the first region 3 includes: a plurality of first sub-regions 501 and at least one second sub-region 502. The second sub-region 502 connects the two first sub-regions 501.

In the first sub-region 501, the signal lines 201 extend along the second direction Y, and in the second sub-region 502, the signal lines 201 extend along the third direction X1. The second direction Y crosses the first direction X. The angle a1 between the direction of the third direction X1 and a direction from the first peripheral region 102-1 corresponding to the second sub-region 502 to the display region 101 is greater than 0° and less than 90°.

It should be noted that the first peripheral region 102 shown in FIG. 2 is the first peripheral region 102-1 on the left side of the display region 101. FIG. 3 is a schematic diagram of Enlarged region A in FIG. 2. In FIG. 2, the first direction X is a left-right extension direction. The first peripheral region 102-1 corresponding to the second sub-region 502 is located on the left side of the display region 101. The direction of the first peripheral region 102-1 corresponding to the second sub-region 502 pointing to the display region 101 is the left-to-right direction of the first direction X. The third direction X1 is a direction inclined to the display region 101.

It should be noted that in FIG. 2, the first sub-region 501 marked as 501-1 is located on a side of the second sub-region 502 away from the second region (not shown), and the first sub-region 501 marked as 501-2 is located on a side of the second sub-region 502 near the second region (not shown). That is, the distance L18 between the edge of the first sub-region 501 marked as 501-2 away from the edge of the display region 101 to the display region 101 is less than the distance L19 between the edge of the first sub-region 501 marked as 501-1 away from the edge of the display region 101 and the display region 101.

That is, in the display substrate provided in the embodiment of the present disclosure, the signal line group extends upward, first changes the extension direction in the second sub-region, and is inclined to one side of the display region, that is, the second sub-region begins to retract to the display region compared with the first sub-region far away from the second region, and the first sub-region close to the second region can also be shrunk to the display region relative to the first sub-region far away from the second region, and a side way from the display region, of the first sub-region close to the second region is increased for the wiring space, which is conducive to setting up other structures.

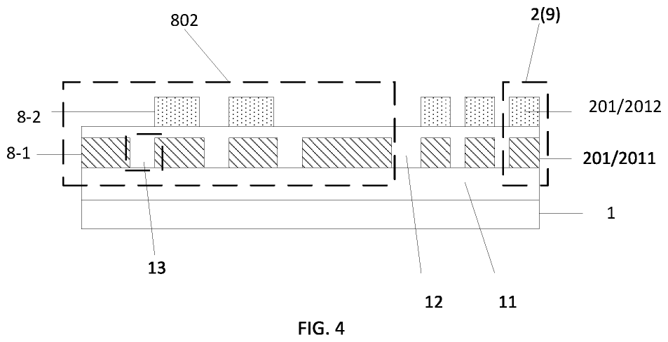

In some embodiments, as shown in FIG. 4, the second signal line 2012 is located on a side of the first signal line 2011 away from the first base substrate 1.

It should be noted that FIG. 4 is a cross-sectional view along BB′ in FIG. 3. As shown in FIG. 4, the display substrate further includes a first insulating layer 11 located between the first base substrate 1 and the first signal line 2011, and a second insulating layer 12 located between the second signal line 2012 and the first signal line 2011.

In the specific embodiment, the sub-pixel unit of the display substrate includes a thin-film transistor. The thin-film transistor includes: an active layer, a gate, a source and a drain. For example, the first signal line is set at the same level as the gate, and the second signal line is set at the same layer as the source and drain. For example, a thin-film transistor can be a bottom-gate structure, i.e., the active layer is located on a side of the gate away from the first base substrate. As shown in FIG. 4, the first insulating layer 11 includes: a buffer layer located between the first base substrate and the gate. The second insulating layer 12 includes a gate insulating layer between the gate and the active layer. Alternatively, for example, a thin-film transistor can be a top-gate structure, that is, the active layer is located between the gate and the first base substrate. As shown in FIG. 4, the first insulating layer 11 includes: a buffer layer located between the first base substrate and the active layer, and a gate insulation layer located between the gate and the active layer. The second insulating layer 12 includes an interlayer insulating layer located between the gate and a layer where the source and the drain are located.

In some embodiments, as shown in FIG. 2, the number of signal lines 201 included in the second sub-region 502 is less than the number of signal lines 201 included in the first sub-region 501 (i.e., the first sub-region 501 marked as 501-1 in FIG. 2) connected with the second sub-region 502 on a side far away from the second region (not shown).

In the specific embodiment, as shown in FIG. 2, in the first sub-region 501 of the reference drawing marked as 501-1, after a part of the signal lines 201 extend to be electrically connected with the scanning line 6, they are no longer extended upward, therefore, the number of signal lines 201 in the first sub-region 501 marked as 501-2 in the drawings is less than the number of signal lines 201 included in the second sub-region 502. Correspondingly, the number of signal lines 201 in the first sub-region 501 marked 501-2 in the drawings is smaller than the number of signal lines 201 in the first sub-region 501 marked 501-1 in the drawings. The wiring space required for the second sub-region 502 is less than the wiring space required for the first sub-region 501 marked as 501-1 in the drawings. The signal lines 201 in the second sub-region 502 is inclined to the side of the display region 101, and do not cause the width of the second peripheral region where the second sub-region is located to increase in the first direction. Correspondingly, the wiring space required for the first sub-region 501 marked as 501-2 in the drawings connected with the second sub-region 502 is also less than the wiring space required for the first sub-region 501 marked as 501-1 in the reference drawing, and after the signal lines of the second sub-region 502 is inclined to one side of the display region, the first sub-region 501 marked as 501-2 retracts relative to the first sub-region 501 marked as 501-1 towards the display region. The wiring space on the side of the first sub-area 501 marked as 501-2 in the drawing far away from the display region 101 is increased, which is conducive to setting up other structures.

In some embodiments, as shown in FIG. 2, the number of signal lines 201 included in the second sub-region 502 is greater than or equal to the number of signal lines 201 included in the first sub-region 501 (i.e., the first sub-region 501 marked as 501-2 in the drawings) connected with the second sub-region 502 on the side close to the second region.

It should be noted that taking the number of signal lines 201 included in the second sub-region 502 in FIG. 2 is equal to the number of signal lines 201 included in the first sub-region 501 (i.e., the first sub-region 501 marked as 501-2 in the drawings) connected with the second sub-region 502 on the side close to the second region as an example, that is, in the first peripheral region 102 corresponding to the second sub-region 502, there is no signal line 201 electrically connected with the scanning line 6, and all signal lines 201 included in the second sub-region 502 extend upwards to the first sub-region 501 marked 501-2 in the drawings.

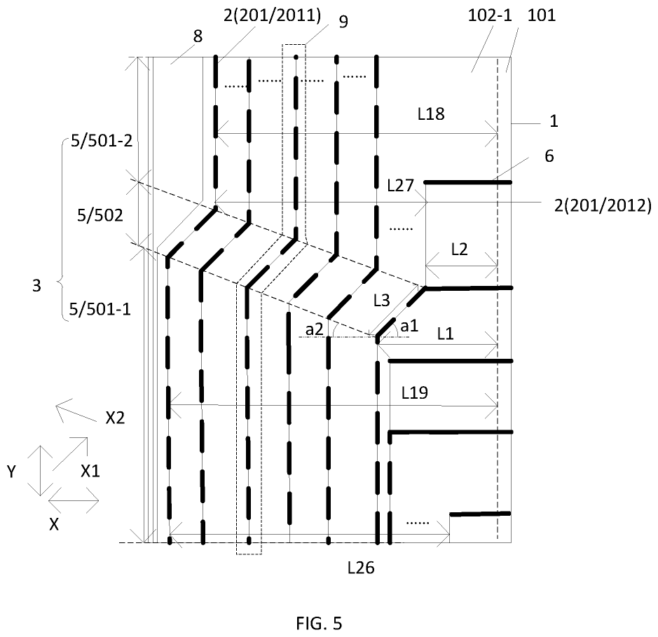

Certainly in the specific embodiment, the number of signal lines 201 included in the second sub-region 502 may also be less than the number of signal lines 201 included in the first sub-region 501 that is connected with the second sub-region 502 on one side close to the second sub-region 4, as shown in FIG. 5, that is, in the first peripheral region 102 corresponding to the second sub-region 502, there is a signal line 201 electrically connected with the scanning line 6, and the signal line 201 electrically connected with the scanning line 6 in the second sub-region 502 does not extend to the first sub-region 501 marked as 501-2 in the drawing. In FIG. 5, taking a first signal line 2011 on a side closest to the display region 101 in the second sub-region 502 is electrically connected with the scanning line 6 in the area corresponding to the second sub-region 502 as an example, that is, the difference between the number of signal lines 201 included in the second sub-region 502 and the number of signal lines 201 included in the first sub-region 501 marked as 501-2 in the drawings is 1.

In some embodiments, as shown in FIG. 3, in the first sub-region 501 and the second sub-region 502, the signal line group 2 includes a plurality of subgroups 9, and at least part of the subgroups 9 includes a first signal line 2011 and a second signal line 2012 of which the orthographic projections on the first base substrate 1 have overlapping regions. In the first sub-region 501 and the second sub-region 502, the line widths L4 of the plurality of subgroups 9 are equal, and the spacing L5 between any two adjacent subgroups 9 is equal. That is, the first signal line 2011 and the second signal line 2012 of which the orthographic projections on the first base substrate 1 have overlapping regions acts as one subgroup 9.

In the specific embodiment, as shown in FIG. 2 and FIG. 5, the number of subgroups 9 included in the second sub-region 502 is less than the number of subgroups 9 included in the first sub-region 501 (i.e., the first sub-region 501 marked as 501-1 in FIG. 2) connected with the second sub-region 502 on the side far away from the second region (not shown), and the number of subgroups 9 included in the first sub-region 501 (i.e., the first sub-region 501 marked as 501-2 in the drawing) connected with the second sub-region 502 on a side close to the second region, is less than the number of subgroups 9 included in the first sub-region 501 (i.e., the first sub-region 501 labeled 501-1 in FIG. 2) connected to the second sub-region 502 on a side away from the second region (not shown).

In the specific embodiment, as shown in FIG. 2, when the number of signal lines 201 included in the second sub-region 502 is equal to the number of signal lines 201 included in the first sub-region 501 (i.e., the first sub-region 501 501 marked as 501-2 in the drawing) connected with the second sub-region 502 on the side close to the second region, the number of subgroups 9 included in the second sub-region 502, is equal to the number of subgroups 9 included in the first sub-region 501 (i.e., the first sub-region 501 marked 501-2 in the drawing) connected to the second sub-region 502 on the side close to the second region.

In the specific embodiment, as shown in FIG. 5, when the number of signal lines 201 included in the second sub-region 502 is greater than the number of signal lines 201 included in the first sub-region 501 (i.e., the first sub-region 501 marked as 501-2 in the drawing) connected with the second sub-region 502 on the side close to the second region, and the difference between the number of signal lines 201 included in the second sub-region 502 and the number of signal lines 201 included in the first sub-region 501 (i.e., the first sub-region 501 marked as 501-2 in the drawing) connected with the second sub-region 502 on the side closed to the second sub-region 4 is less than or equal to 2, the number of subgroups 9 included in the second sub-region 502, is equal to the number of subgroups 9 included in the first sub-region 501 (i.e., the first sub-region 501 marked 501-2 in the drawing) connected to the second sub-region 502 on the side close to the second region.

In the specific embodiment, when the number of signal lines included in the second sub-region is greater than the number of signal lines included in the first sub-region connected with the second sub-region on the side close to the second region, and the difference between the number of signal lines included in the second sub-region and the number of signal lines included in the first sub-region connected to the second sub-region on the side close to the second region is greater than 2, the number of subgroups included in the second sub-region is greater than the number of subgroups included in the first sub-region connected to the second sub-region on the side close to the second region.

In some embodiments, as shown in FIG. 3, in the first sub-region 501 and the second sub-region 502, the orthographic projection of the plurality of first signal lines 2011 on the first base substrate 1 and the orthographic projection of the plurality of second signal lines 2012 on the first base substrate 1 have overlapping regions.

In the first sub-region 501 and the second sub-region 502, the line width of the first signal line 2011 is equal to the line width of the second signal line 2012, and the spacing between any two adjacent signal lines 201 is equal. The line width of the first signal line 2011 and the line width of the second signal line 2012 is the line width L4 of subgroup 9.

In some embodiments, L4=3.5 μm and L5=2 μm.

Certainly in the specific embodiment, it can also be that the line width of the first signal line is not equal to the line width of the second signal line, the orthographic projection of the first signal line on the first base substrate and the orthographic projection of the second signal line on the first base substrate have overlapping areas, the orthographic projection of the first signal line on the first base substrate falls into the orthographic projection of the second signal line on the first base substrate. Alternatively, the orthotropic projection of the second signal line on the first base substrate falls into the orthographic projection of the first signal line on the first base substrate. The line width of the subgroup is the wider one in the line width of the first signal line and the line width of the second signal line, and the spacing between adjacent subgroups is the distance between the signal lines with the wider line width.

In some embodiments, L4=3.5 μm and L5=2 μm.

In the specific embodiment, when the line width of the first signal line is equal to the line width of the second signal line, the line width of the first signal line and the line width of the second signal line are both 3.5 μm, the spacing of the adjacent first signal lines is 2 μm, and the spacing of the adjacent second signals line is 2 μm. When the line width of the first signal line is not equal to the line width of the second signal line, for example, the line width of the first signal line is 3.5 μm, the spacing of the adjacent first signal lines is 2 μm, the line width of the second signal line is 3 μm, and the spacing of the adjacent second signal line is 2.5 μm.

In some embodiments, as shown in FIG. 2 and FIG. 5, in the two first sub-regions 501 connected by the second sub-region 502, the maximum width L26 of the first sub-region 501 (i.e., the first sub-region 501 marked as 501-1) away from the second region (not shown) in the first direction X is greater than the maximum width L27 of the first sub-region 501 (i.e., the first sub-region 501 marked as 501-2 in the drawing) close to the second region 501 in the first direction X.

In the specific implementation, as shown in FIG. 2 and FIG. 5, in a case that the number of signal lines 201 in the first sub-region far away from the second region is greater than the number of signal lines 201 in the first sub-region close to the second region, and the line width L4 of each subgroup is equal and the spacing L5 between two adjacent subgroups is equal, L26 is greater than L27.

In some embodiments, as shown in FIG. 2 and FIG. 5, in the two first sub-regions 501 connected by the second sub-region 502, in the first sub-region 501 (i.e., the first sub-region 501 marked as 501-1 in the drawing) far away from the second region, the signal line 201 closest to the display region 101 at the connection with the second sub-region 502 has a first distance L1 from the display region 101 in the first direction X; in the first sub-region 501 close to the second sub-region 4 (i.e., the first sub-region 501 marked as 501-2 in the drawing), the signal line 201 closest to the display region 101 at the connection with the second sub-region has a second distance L2 from the display region 101 in the first direction X, L2<L1.

In some embodiments, as shown in FIG. 2 and FIG. 5, the length of the signal line 201 closest to the display region 101 in the second sub-region 502 is L3 in the extension direction of the signal line 201. L1, L2, and L3 satisfy:

$$L 2 ⩾ L 1 - L 3 \times cos a 1.$$

It should be noted that in FIG. 2 and FIG. 5, taking L2=L1−L3×cos a1 as an example. In the specific implementation, as shown in FIG. 2 and FIG. 5, when the number of subgroups 9 included in the second sub-region 502 is equal to the number of subgroups 9 included in the first sub-region 501 (i.e., the first subgroup 501 marked as 501-2 in the drawing) connected with the second sub-region 502 close to the second region, L2=L1−L3×cos a1. In the specific implementation, when the number of subgroups included in the second sub-region is greater than the number of subgroups included in the first sub-region connected to the second sub-region close to the second region, L2>L1−L3×cos a1.

In the specific implementation, when the width of the second peripheral region in the first direction is determined, the number of signal lines included in the signal line group, the line width, and the spacing are determined, L1, L2, and L3 can be specifically set according to the number of subgroups included in the signal line group of each sub-region and the actual width of the second peripheral region in the first direction.

In some embodiments, in the two first sub-regions connected with the second sub-region, the first sub-region away from the second region includes m subgroups, and the first sub-region close to the second region includes n subgroups, m>n, and m, n are both positive integers.

The line width L4 of the subgroup, the spacing between adjacent subgroups L5, the first distance L1, and the second distance L2 satisfy:

$$[ m \times L 4 + ( m - 1 ) \times L 5 ] - [ n \times L 4 + ( n - 1 ) \times L 5 ] ⩽ L 1 - L 2.$$

It should be noted that in the specific implementation, in different sub-regions, the distance between the signal line closest to the display region and the display region needs to be greater than 0 and greater than a preset value.

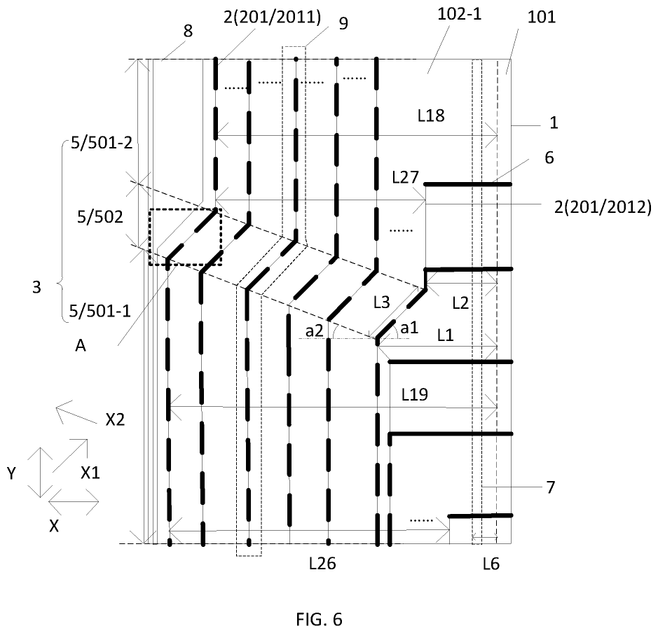

In some embodiments, as shown in FIG. 6, between the signal line group 2 and the display region 101, the display substrate further includes an electrostatic unit 7. The distance between the edge of the electrostatic unit 7 close to the signal line group 2 and the display region 101 is L6 in the first direction X. L2 and L6 satisfy: L2−L6 is greater than 0.

In the specific implementation, L2−L6 is set to be greater than 2 μm in order to avoid the influence of the signal lines included in the signal line group on the electrostatic unit. Preferably, e.g., L2−L6 larger than 3 μm.

In the specific implementation, if the width of the first peripheral region in the first direction is 0.9 mm, usually, L6 is about 90 μm. Correspondingly, L2 is greater than 92 μm, and preferably L2 is greater than 93 μm. In some embodiments, L2 is 140 μm and L1 is 245 μm.

In the specific embodiment, the electrostatic unit includes a plurality of first subunits and a second subunit arranged in the second direction. In the direction from the first region to the second region, the second subunit is located on a side of the plurality of first subunits. For example, one first subunit is electrically connected with one scanning line, and the second subunit is electrically connected with a third signal line. The number of first subunits included in an electrostatic unit is equal to the number of signal lines in a signal line group. The first subunit, as well as the second subunit, include, for example, thin-film transistors.

In some embodiments, as shown in FIG. 2 and FIG. 3, a plurality of signal lines 201 included in the second sub-region 502 are equal in length L3 in their extension directions.

In some embodiments, as shown in FIG. 2, the edge of the connection between the second sub-region 502 and the first sub-region 501 extends along the fourth direction X2, and the angle a2 between the fourth direction X2 and a direction of the display region 101 pointing to the second sub-region 502 at a side of the first peripheral region 102-1 (i.e., the first direction extending from right to left in FIG. 2) is greater than 0° and less than 90°.

In some embodiments, a1 is greater than or equal to 30° and less than or equal to 60°, and a2 is greater than or equal to 15° and less than or equal to 30°.

In some embodiments, as shown in FIG. 2, a1 is 45° and a2 is 23°.

In a specific implementation, L3 is about 148 μm when L2 is 140 μm, L1 is 245 μm, and a1 is 45°.

It should be noted that a1 and a2 can be set according to actual needs. a1 is 45°, which is conducive to maintaining parallel retraction in the display region in the extension direction of multiple subgroups included in the signal line group, and avoiding the increase of the space required for the second sub-region due to the large size of a1.

In some embodiments, as shown in FIG. 2, FIG. 3, FIG. 5, FIG. 6, the display substrate further includes:
a third signal line 8 located on a side of the first base substrate 1 in the peripheral region 102. In the first direction X, the third signal line 8 in the first peripheral region 102-1 is located on a side of the signal line group 2 far away from the display region 101. The third signal line 8 includes a first part 801, and a second part 802. The second part 802 is adjacent to at least the second sub-region 502 and the first sub-region 501 connected to the second sub-region 502 on the side close to the second region 4.

As shown in FIG. 3, in the first direction X, the maximum width L20 of the first part 801 is smaller than the maximum width L22 of the second part 802. The second part 802 includes: a first sublayer 8-1 and a second sublayer 8-2 located on a side of the first sublayer 8-1 away from the first base substrate 1.

In some embodiments, the display substrate is an array substrate of a liquid crystal display panel, that is, the sub-pixel units included in the display substrate further include pixel electrodes positioned on a side of the thin-film transistor away from the first base substrate. The display substrate further includes a common electrode arranged as a whole surface. The common can be arranged between the pixel electrodes and the layer where the source and drain are located, or it can be arranged on a side of the pixel electrodes away from the first base substrate. The third signal line is electrically connected to the common electrode.

It should be noted that when the display substrate is applied to the liquid crystal display panel, the liquid crystal display panel also includes an opposing substrate arranged opposite to the display substrate. The encapsulant needs to be arranged in the peripheral region between the display substrate and the opposing substrate, and the encapsulant usually includes supporting silicon (Si) balls. In the related art, the area where the signal line groups are arranged in an overlapping manner does not include the area that retracts into the display region, that is, the wiring space on the side of the signal line group away from the display region is smaller. The third signal line is on a single layer. The thickness of the display substrate in the area where the third signal line is located is smaller than the thickness of the display substrate in the area where the signal lines overlaps in two layers, that is, the thickness uniformity of the display substrate corresponding to the supporting silicon (Si) balls is poor, which is easy to cause the screen of the display panel to be yellow.

The display substrate provided in the embodiment of the present disclosure is that the signal line group begins to retract to the display region in the second sub-region, and the wiring space of the second sub-region and a side far away from the display region, of the first sub-region close to the second region is increased, so that the width of the third signal line can be increased in the second sub-region and on a side far away from the display region, of the first sub-region close to the second region, so that the third signal line has enough space for double-layer wiring, that is, the double-layer wiring includes the first sub-layer and the second sub-layer, and the thickness uniformity of the display substrate in the first peripheral region is conducive to being improved. In this way, when the display substrate is applied to the liquid crystal display panel, the problem of yellowing of the display panel due to the poor thickness uniformity of the display substrate corresponding to the supporting silicon balls can be alleviated or even avoided, and the display effect can be improved. Moreover, the width of the second part of the third signal line is increased, and is also conducive to increasing the resistance of the third signal line and thereby alleviating the voltage drop of the third signal line.

In some embodiments, as shown in FIG. 3, the edge of the second part 802 adjacent to the second sub-region 502 is parallel to the extension direction of the signal lines included in the second sub-region 502. That is, the edge of the second part adjacent to the second sub-region extends along the third direction.

In some embodiments, as shown in FIG. 3, in the first peripheral region, the spacing between the second part 802 and the different sub-regions 5 of the signal line group 2 is approximately equal.

It should be noted that the spacing between the second part and the different sub-regions of the signal line group is roughly equal, which means that the difference of the spacings between the second part and the different sub-regions of the signal line group is within a reasonable process error range, regarding as that the spacing between the second part and the different sub-regions of the signal line group is equal.

For example, as shown in FIG. 3, the spacing L24 between the second part 802 and the second sub-region 502 is equal to the spacing L25 between the second part 802 and the first sub-region 501-2.

In some embodiments, as shown in FIG. 3, in the first peripheral region, the spacing L23 between the first part 801 and the first sub-region 501-1 of the signal line group 2 is equal to the spacing L25 between the second part 802 and the first sub-region 501-2.

In specific implementation, when L23=L24=L25, L22−L20≤L2−L1. If L2 is 140 μm and L1 is 245 μm, then L22−L20≤105 μm, which can be set to L22−L20=105 μm, that is, the line width of the second part is increased by 105 μm compared with the first part.

In some embodiments, as shown in FIG. 3, the pattern of the orthographic projection of the first sublayer 8-1 on the first base substrate 1 is grid-shaped. i.e., the first sublayer 8-1 includes a plurality of first opening regions 13.

It should be noted that when the display substrate is applied to the liquid crystal display panel, the encapsulant is usually UV-curing adhesive, that is, ultraviolet light is required after gluing. The pattern of the orthographic projection of the first sublayer on the first base substrate is grid-shaped, which is conducive to improving the transmittance of ultraviolet light and the curing yield of ultraviolet-curing adhesive.

In some embodiments, as shown in FIG. 3 and FIG. 4, the orthographic projection of the second sublayer 8-2 on the first base substrate 1 falls into the orthographic projection of the first sublayer 8-1 on the first base substrate.

In the specific embodiment, as shown in FIG. 3 and FIG. 4, the orthographic projection of the second sublayer 8-2 on the first base substrate 1 falls into the orthographic projection of the grid pattern of the first sublayer 8-1 in the first base substrate. As shown in FIG. 3 and FIG. 4, the orthographic projection of the second sublayer 8-2 on the first base substrate 1 and the orthographic projection of the first opening regions 13 on the first base substrate do not overlap with each other. In this way, the second sublayer can be avoided from affecting the transmittance of ultraviolet light.

Alternatively, in the second part, the orthotropic projection of the second sublayer on the first base substrate coincides with the orthographic projection of the grid pattern of the first sublayer on the first base substrate.

In some embodiments, as shown in FIG. 3 and FIG. 4, the first sublayer 8-1 is arranged on the same layer as the first signal lines 2011, and the second sublayer 8-2 is arranged on the same layer as the second signal lines 2012.

In some embodiments, as shown in FIG. 3, the first part 801 includes only the first sublayer 8-1.

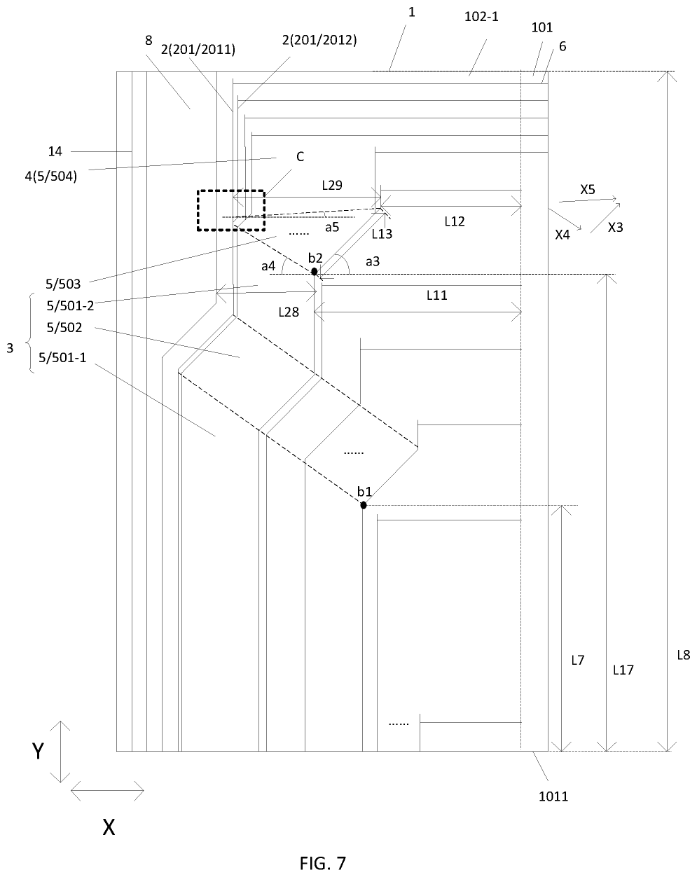

In some embodiments, as shown in FIG. 7, the first region 3 includes a second sub-region 502. The display region 101 includes a first edge 1011 extending along the first direction X. The extension of the first edge 1011 is located on a side of the first region 3 away from the second region 4.

In the second direction Y, there is a third distance L7 between the signal line 201 closest to the display region 101 in the second sub-region 502 and the junction b1 where signal line 201 closet to the display region 101 is connected with the first sub-region 501 far away from the second region 4. The third distance L7 and the width L8 of the display region 101 in the second direction Y satisfies L7=L8/3.

It should be noted that the display region involved in the embodiment of the present disclosure corresponds to the area where the display substrate is displayed when it is applied to the display product, and the peripheral region involved in the embodiment of the present disclosure corresponds to the area that does not require image display.

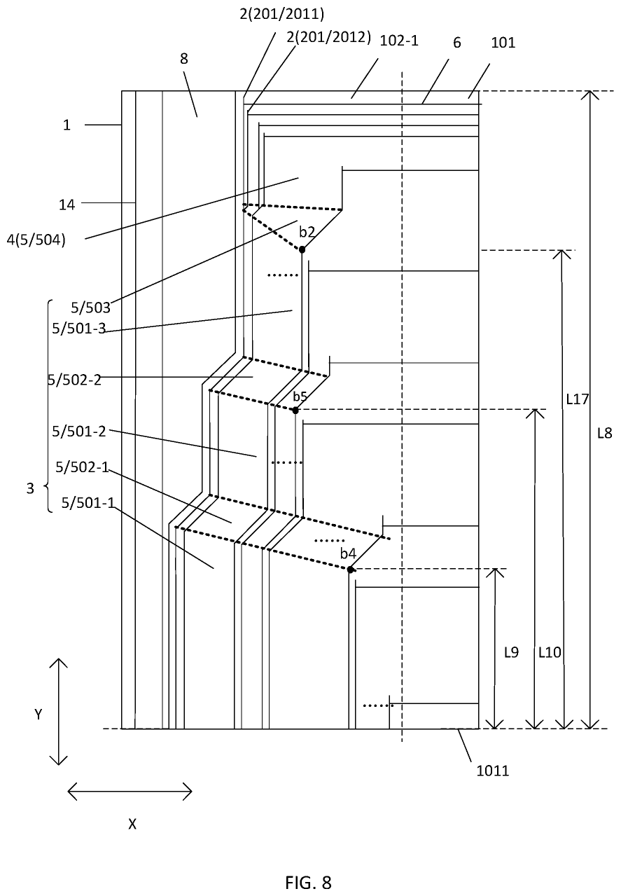

Alternatively, in some embodiments, as shown in FIG. 8, the first region 3 includes two second sub-regions 502, which are marked as 502-1 and 502-2, respectively. The display region 101 includes a first edge 1011 extending along the first direction X. The extension line of the first edge 1011 is located on a side of the first region 3 away from the second region 4.

In the second direction Y, in the second sub-region 502 away from the second region 4 (i.e., the second sub-region 502 marked as 502-1), there is a fourth distance L9 between the junction b4 where the signal line 201 closet to the display region 101 is connected with the first sub-region 501 away from the second region 4 (i.e., the first sub-region 501 marked as 501-1) and the first edge 1011. In the second direction Y, in the second sub-region 502 (i.e., the second sub-region 502 marked as 502-2) close to the second region, the is a fifth distance L10 between the junction b5 where the signal line 201 closest to the display region 101 is connected with the first sub-region 501 away from the second region 4 (i.e., the first sub-region 501 marked as 501-2) and the first edge 1011. The fourth distance L9 and the width L8 of the display region 101 in the second direction Y satisfies: L9=L8/4, and the fifth distance L10 and the width L8 of the display region 101 in the second direction Y satisfies: L10=L8/2.

It should be noted that the display region is a rectangle, and the edges of the rectangle is the edges of the display region, and one pair of edges of the display region extends along the first direction X, and the other pair of edges extends along the second direction Y. The first edge extending along the first direction X included in the display region, is the boundary between the display region and the second peripheral region.

The first region includes two second sub-regions, i.e., the signal line group is retracted twice from the first region to the side of the display region.

In specific implementation, the first region may also include a plurality of second sub-regions, that is, the signal line group is retracted more times to the display region in the first region. It should be noted that the number of the second sub-regions included in the first region, that is, the number of times that the signal line group is retracted to the display region in the first region, can be specifically set according to the number of signal lines included in the signal line group and the size of the first peripheral region, as long as in the direction of the extension of the signal line group. After the number of signal lines is reduced, there is enough wiring space to make the second distance L2 to meet the requirements after the signal line group retracts.

In some embodiments, the fourth distance L9 is less than the third distance L7 in a case that the first region includes two second sub-regions, in comparison to a case that the first region includes one second sub-region. Correspondingly, the length of the first part of the third signal line in the second direction in a case that the first region includes two second sub-regions, is less than the length of the first part of the third signal line in the second direction in a case that the first region includes one second sub-region, that is, when the first region includes two second sub-regions, the first part of the third signal line arranged in a single layer occupies a smaller area, which is more conducive to improving the thickness uniformity of the display substrate in the peripheral region and avoiding the problem of yellowing of the display.

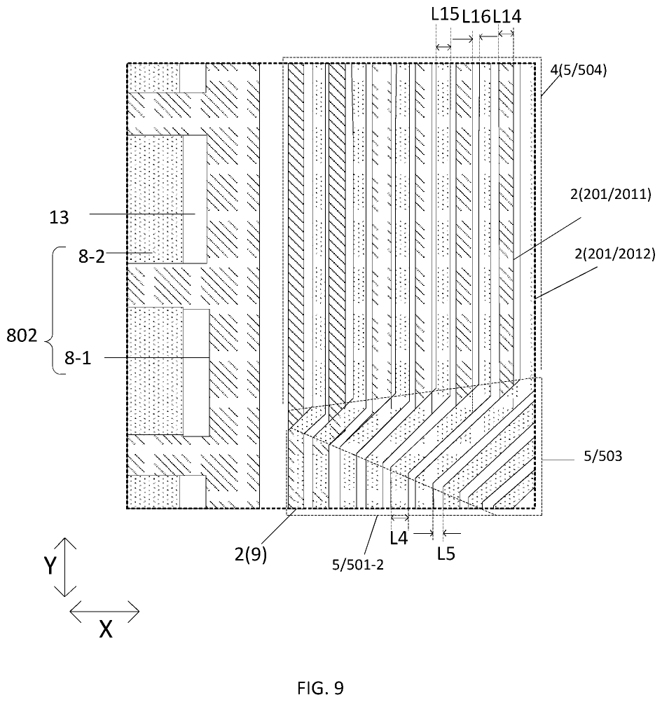

In some embodiments, as shown in FIG. 7 and FIG. 9, the first region 3 further includes a third sub-region 503. The second region 4 includes: a fourth sub-region 504 connected with the third sub-region 503. The third sub-region 503 is connected with the first sub-region 501 closest to the second region 4 (i.e., the first sub-region 501 marked as 501-2 in the drawing);

The signal lines 201 in the fourth sub-region 504 extend along the second direction Y. At least part of the signal lines 201 in the third sub-region 503 includes portions extending along the fifth direction X3. The angle a3 between the fifth direction X3 and the direction of one side of the first peripheral region 102-1 corresponding a direction from the display region 101 to the second sub-region 502 is greater than 0° and less than 90°.

It should be noted that FIG. 9 is a schematic diagram of the enlarged region C in FIG. 7.

It should be noted that the signal line group continues to extend upwards after passing through the first sub-region close to the second region, the number of signal lines included in the signal line group continues to decrease with the upward extension of the signal line group. The number of signal lines included in the fourth sub-region is much less than the maximum number of signal lines included in the first region. A plurality of first signal lines and a plurality of second signal lines in the fourth sub-region of the second region can be arranged alternately in the second region without increasing the width of the second peripheral region in the first direction, thereby avoiding the overlapping of signal lines that will increase the capacitance and affect the charging of sub-pixels.

The display substrate provided in the embodiment of the present disclosure is that the signal line group extends to the third sub-region and changes the extension direction. The signal line closest to the display region extends along the fifth direction and is deflected to a side of the display region, so that the plurality of signal lines are arranged alternately in the fourth sub-region with sufficient space to avoid the increase of capacitance caused by the overlapping of signal lines and affect the charging of sub-pixels.

In some embodiments, as shown in FIG. 7, the number of signal lines 201 included in the third sub-region 503 is smaller than the number of signal lines 201 included in the first sub-region 501 (i.e., the first sub-region 501 marked as 501-2 in the drawing) closest to the second region 4.

Correspondingly, as shown in FIG. 7, the number of signal lines 201 included in the fourth sub-region 504 is less than the number of signal lines 201 included in the first sub-region 501 (i.e., the first sub-region 501 marked as 501-2 in the drawing) closest to the second region 4.

In some embodiments, as shown in FIG. 7, the number of signal lines 201 included in the fourth sub-region 504 is less than or equal to the number of signal lines 201 included in the third sub-region 503.

It should be noted that FIG. 7 takes the number of signal lines 201 included in the fourth sub-region 504 equal to the number of signal lines 201 included in the third sub-region 503 as an example. In the first periphery area 102 corresponding to the third sub-region 503, there is no signal line 201 electrically connected with the scanning line 6, and all signal lines 201 included in the third sub-region 503 extend upwards to the fourth sub-region 504.

Certainly in the specific implementation, the number of signal lines included in the fourth sub-region can also be made smaller than the number of signal lines included in the third sub-region, that is, in the first peripheral region corresponding to the third sub-region, there are signal lines and scanning lines that are electrically connected, and the signal lines included in the third sub-region do not need to extend to the fourth sub-region.

Since in the fourth sub-region, the first signal lines and the second signal lines are alternately arranged along the first direction. In some embodiments, as shown in FIG. 7, the minimum width L28 of the first sub-region 501 (i.e., the first sub-region 501 marked as 501-2 in the drawing) closest to the second region 4 is less than the maximum width L29 of the fourth sub-region 504 in the first direction X.

In some embodiments, as shown in FIG. 7, the signal line 201 far away from the display region 101 in the first sub-region 501 (i.e., the first sub-region 501 marked as 501-2 in the drawing) connected by the third sub-region 503 and the signal line 201 far away from the display region 101 in the fourth sub-region 504 are located in the same straight line.

That is, the extension direction and extension position of a signal line farther away from the display region of the signal line group have not changed after the signal line farther away from the display region of the signal line group passing through the third sub-region and the fourth sub-region, that is, the signal line of the fourth sub-region furthest from the display region does not need to be retracted inwardly, so as to provide sufficient wiring space for the first signal lines and the second signals line being alternately arranged along the first direction.

In some embodiments, as shown in FIG. 7, in the first direction X, there is a sixth distance L11 between a junction of the signal line 201 closest to the display region 101 in the first sub-region 501 (i.e., the first sub-region 501 marked as 501-2 in the drawing) closest to the second region 4 and the third sub-region 503, and there is a seventh distance L12 between the signal line 201 closest to the display region 101 of the fourth sub-region 504 and the display region 101. The length of the signal line 201 closest to the display region 101 in the third sub-region 503 is L13 in the extension direction of the signal line 201;
L11, L12, and L13 satisfy:

$$L 12 < L 11 ;$$

$$L 12 ⩾ L 11 - L 13 \times cos a 3.$$

It should be noted that in FIG. 7, L12=L11−L13×cos a3 is used as an example. In the specific implementation, as shown in FIG. 7, when twice of the number of subgroup 9 included in the third sub-region 503 is equal to the number of signal lines 2 included in the fourth sub-region 504, L12=L11−L13×cos a3. In the specific implementation, when twice of the number of subgroups included in the third sub-region is greater than the number of signal lines included in the fourth sub-region, L12>L11−L13×cos a3.

In the specific implementation, when the width of the second peripheral region in the first direction is determined, the number of signal lines included in the signal line group, the line width and the spacing are determined, L11, L12 and L13 can be specifically set according to the number of signal lines included in each subgroup of the signal line group and the actual width of the second peripheral region in the first direction.

In some embodiments, as shown in FIG. 7, in the first sub-region 501 and the third sub-region 503, the signal line group 2 includes a plurality of subgroups 9.

As shown in FIG. 9, in the fourth sub-region 504, the first signal line 2011 has a first line width L14, the second signal line 2012 has a second line width L15 line width, and the distance between the first signal line 2011 and the second signal line 2012 is L16.

In some embodiments, the first sub-region 501 closest to the second region 4 includes k subgroups. The fourth sub-region includes e1 first signal lines and e2 second signal lines; e1, e2, k are positive integers, e1+e2<2k.

e1, e2, k, L11, L12, L14, L15, L16, the line width L4 of the subgroup 9 and the spacing L5 between the adjacent subgroups 9 satisfy the following:

$$[ e 1 \times L 14 + e 2 \times L 15 + ( e 1 + e 2 - 1 ) \times L 16 ] - [ k \times L 4 + ( k - 1 ) \times L 5 ] ⩽ L 11 - L 12.$$

It should be noted that k is used here to represent the number of subgroups included in the first sub-region closest to the second region, and the aforementioned “the first sub-region away from the second region includes m subgroups”, when the first sub-region away from the second region is the first sub-region closest to the second region, that is, the first sub-region away from the second region and the first sub-region closest to the second region are the same region, k=m.

In some embodiments, L4=3.5 μm, L5=2 μm; L14=3.5 μm, L15=3 μm, L16=1.25 μm.

It should be noted that in the specific implementation, in different sub-regions, the distance between the signal line closest to the display region and the display region needs to be greater than 0 and greater than a preset value.

In some embodiments, when the display substrate also includes an electrostatic unit, L12 and L6 satisfy: L12−L6 are greater than 0.

In the specific implementation, in order to avoid the influence of the signal lines included in the signal line group on the electrostatic unit, L12−L6 is larger than 2 μm. Preferably, e.g., L12−L6 larger than 3 μm.

In the specific implementation, if the width of the first peripheral region in the first direction is 0.9 mm, usually, L6 is about 90 μm. Correspondingly, L12 is greater than 92 μm, and preferably L12 is greater than 93 μm. In some embodiments, L12 is 285 μm.

In some embodiments, as shown in FIG. 7, in the direction from the first peripheral region 102-1 corresponding to the third sub-region 503 to the display region 101, the length of the plurality of first signal lines 2011 included in the third sub-region 503 gradually increases in the extension direction of the first signal lines, and the length of the plurality of second signal lines 2012 included in the third sub-region 503 gradually increases in the extension direction of the second signal lines.

In some embodiments, as shown in FIG. 7, the edge at the junction between the third sub-region 503 and the first sub-region 501 (i.e., the first sub-region 501 marked as 501-2 in the drawing) extends along the ninth direction X4. The angle a4 between the ninth direction X4 and the direction from the display region 101 to a side of the first peripheral region 102-1 corresponding to the second sub-region 502 is greater than 0° and less than 90°.

The edge of the junction between the third sub-region 503 and the fourth sub-region 504 extends along the sixth direction X5. The angle a5 between the sixth direction X5 and a direction from the first peripheral region 102-1 corresponding to the second sub-region 502 to the display region 101 is greater than 0° and less than 90°.

In some embodiments, a3 is greater than or equal to 30° and less than or equal to 60°, a4 is greater than or equal to 15° and less than or equal to 30°, and a5 is greater than or equal to 5° and less than or equal to 15°.

In some embodiments, a3 is 45° a4 is 22.5°, and a5 is 8°.

It should be noted that a3, a4, and a5 can be set according to the actual wiring space of the third sub-region and the fourth sub-region.

In some embodiments, as shown in FIG. 7, the first region 3 includes a second sub-region 502. The display region 101 includes a first edge 1011 extending along the first direction X. The extension line of the first edge 1011 is located on a side of the first region 3 away from the second region 4.

In the second direction Y, there is an eighth distance L17 between the junction b2 of the signal line 201 closest to the display region 101 in the third sub-region 503 and the first sub-region 501 (i.e., the first sub-region 501 marked as 501-2 in the drawing) and the first edge 1011. The eighth distance L17 and the width L8 of the display region 101 on the second direction Y satisfy: L17=2×L8/3.

Alternatively, in some embodiments, as shown in FIG. 8, the first region 3 includes two second sub-regions 502. The display region 101 includes a first edge 1011 extending along the first direction X. The extension line of the first edge 1011 is located on a side of the first region 3 away from the second region 4.

In the second direction Y, there is an eighth distance L17 between the junction b2 of the signal line 201 closest to the display region 101 in the third sub-region 503 and the first sub-region 501 (i.e., the first sub-region 501 marked as 501-2 in the drawing) and the first edge 1011. The eighth distance L17 and the width L8 of the display region 101 in the second direction Y satisfy: L17=3×L8/4.

In some embodiments, as shown in FIG. 9, the second part 802 is adjacent to the third sub-region 503 and the fourth sub-region 504.

In some embodiments, the extension direction of at least part of the edge of the second part close to the signal line group is parallel to the extension direction of the signal lines in the third sub-region and the fourth sub-region furthest from the display region.

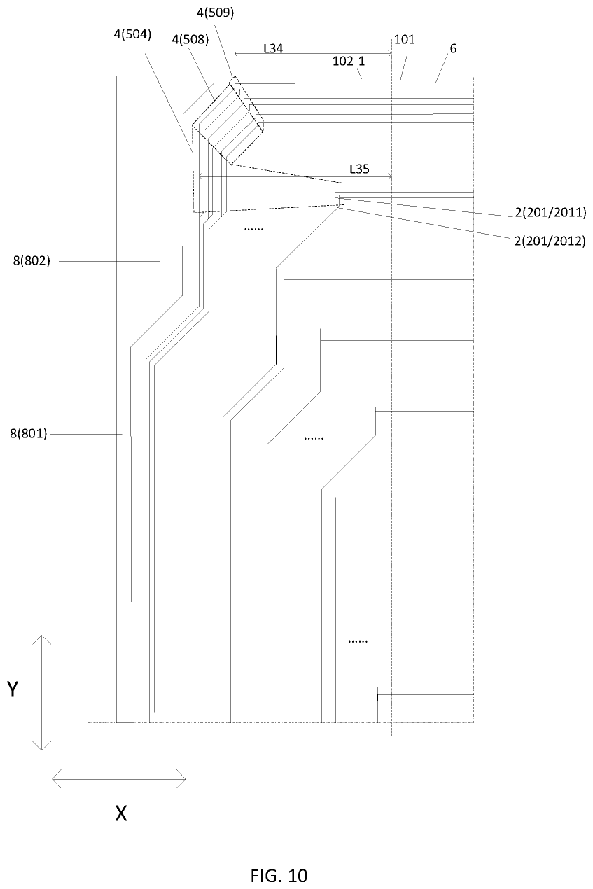

In some embodiments, as shown in FIG. 10, the second region 4 further includes an eighth sub-region 508 and a ninth sub-region 509. The eighth sub-region 508 connects the fourth sub-region 504 with the ninth sub-region 509. The extension direction of the signal lines in the eighth sub-region 508 intersects with the second direction Y and the first direction X. The distance L34 between the edge of the ninth sub-region 509 away from the display region 101 and the display region 101 is less than the distance L35 between the edge of the fourth sub-region 504 away from the display region 101 and the display region 101.

In the display substrate provided in the embodiment of the present disclosure, the signal line group begins to retract towards the display region in the eighth sub-region of the second region, and the width of the part of the second part adjacent to the eighth sub-region and the ninth region is further increased, which is more conducive to increasing the resistance of the third signal line thereby alleviating the voltage drop of the third signal line.

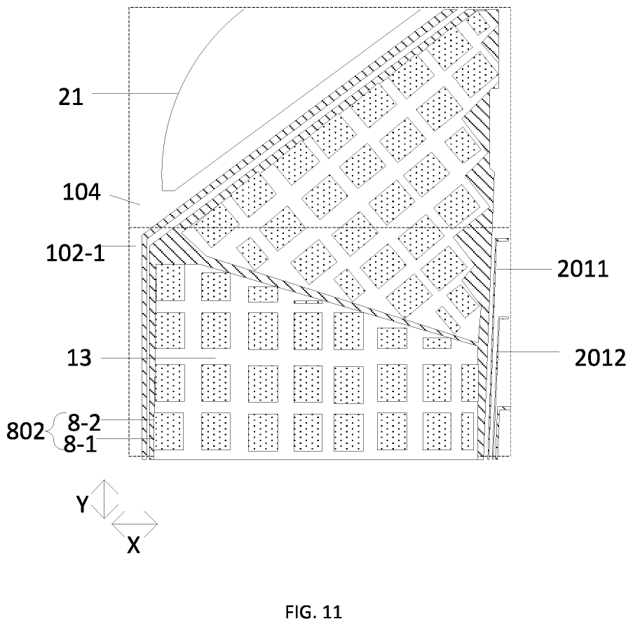

In some embodiments, as shown in FIG. 1, the peripheral region 102 further includes a third peripheral region 104 located on a side of the display region 101 in the second direction Y. The third peripheral region 104 is located above the display region 101. FIG. 11 is a schematic diagram of the enlarged region E in FIG. 1. In the third periphery area 104, the extension direction of the edge of the second part 802 of the third signal line 8 away from the signal line group 2 intersects with both the first direction X and the second direction Y, and the extension direction of the edge is deflected towards the display region, that is, in the third peripheral region 104, the second part 802 is retracted towards the display region 101, so that other structures, such as a dummy structure (dummy) 21 in FIG. 11 for preventing the accumulation of static electricity, can be arranged in the side of the second part 802 far away from the display region 101.

In some embodiments, as shown in FIG. 1, the peripheral region 102 further includes a second peripheral region 103 located on a side of the display region 101 in the second direction Y.

The third region 10 includes a fifth sub-region 505 and a sixth sub-region 506.

The fifth sub-region 505 connects the sixth sub-region 506 with the first region 3. The signal lines 201 in the fifth sub-region 505 extend along the second direction Y, and the extension direction of at least part of the signal lines 201 in the sixth sub-region 506 intersects with the second direction Y and the first direction X.

In the fifth sub-region 505, the orthographic projection of the first signal lines 2011 on the first base substrate 1 overlaps with the orthographic projection of the second signal lines 2012 on the first base substrate 1. In the sixth sub-region 506, a plurality of first signal lines 2011 and a plurality of second signal lines 2012 are alternately arranged along the first direction X.

In some embodiments, as shown in FIG. 1, the third region 10 further includes a tenth sub-region 510. The tenth sub-region 510 is connected with the sixth sub-region 506 and the signal terminals (not shown) of the bonding region 1031. In the tenth sub-region 510, a plurality of first signal lines 2011 and a plurality of second signal lines 2012 are alternately arranged along the first direction X, and the plurality of first signal lines 2011 and the plurality of second signal lines 2012 extend along the second direction Y.

In the specific implementation, the signal line group is led from the bonding region of the second peripheral region, and the number of signal lines included in the signal line group in different sub-regions remains unchanged before reaching the first peripheral region. In the second peripheral region, the signal line group has sufficient wiring space, so in the part that is electrically connected with the signal terminals, i.e., the tenth sub-region, the signal lines of the signal line group can be alternately routed, that is, the first signal lines and the second signal lines are arranged alternately, so as to avoid the overlapping of the signal lines to cause the capacitance to increase and affect the charging of the sub-pixels. When the signal line group extends to the first peripheral region, the wiring space of the first region where the total number of signal lines does not change becomes smaller, so the signal line group adopts overlapping wiring in the first region. In the second periphery area, the fifth sub-region connected between the signal line group and the first region also adopts overlapping wiring, that is, the signal lines of the signal line group adopt alternately wiring along the first direction in the tenth sub-region, the extension direction of the signal lines of the signal line group is changed in the sixth sub-region, and changed again in the fifth sub-region and the signal lines of the signal line group adopt overlapping wiring in the fifth sub-region, compared with directly changing the alternate wiring to overlapping wiring at the boundary between the second periphery region and the first periphery region, it is conducive to the rational use of the space of the second periphery region and reducing the difficulty of wiring.

In the specific implementation, the extension direction of any signal line of the signal line group in the fifth sub-region and the extension direction of the any signal line in the first sub-region connected with the fifth sub-region is in the same straight line, that is, the extension direction of the signal line group passing through the fifth sub-region and the first sub-region connected with the fifth sub-region remains unchanged.

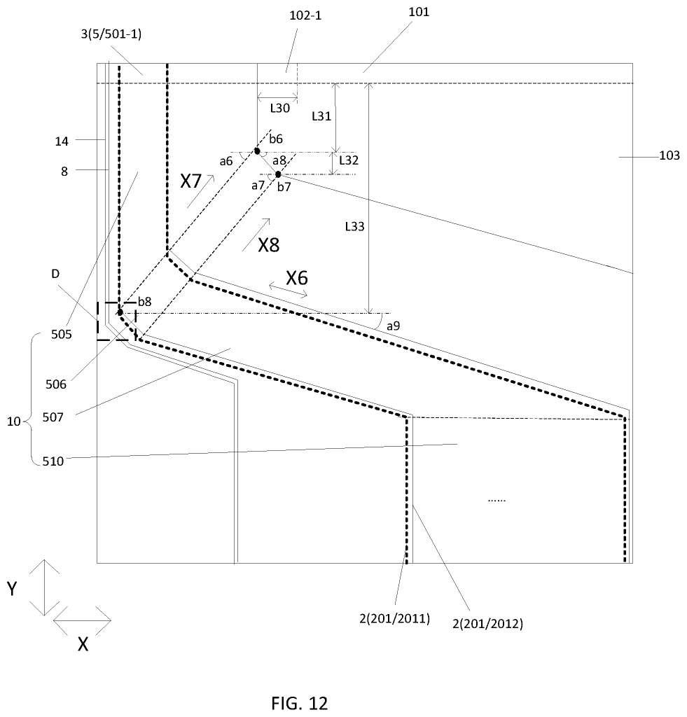

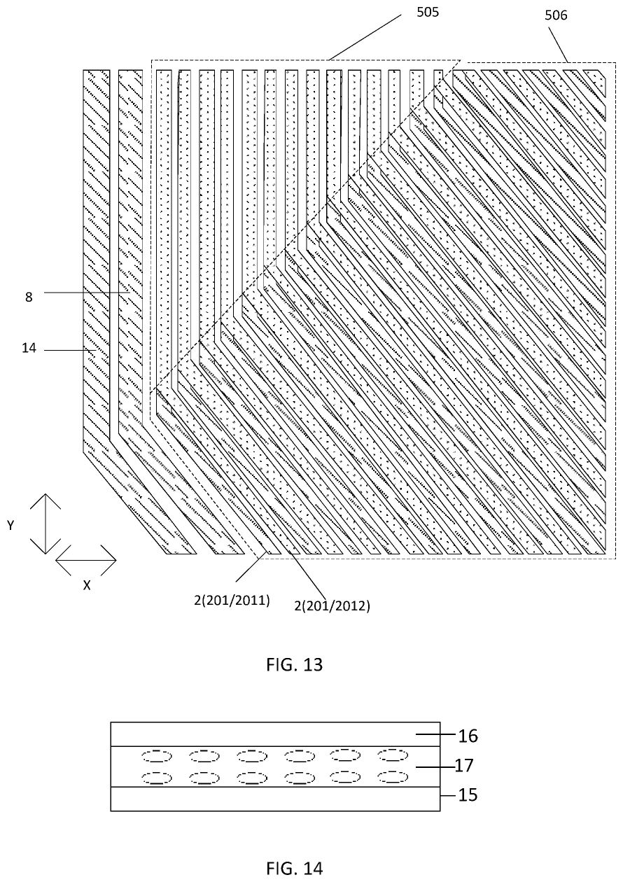

Alternatively, in some embodiments, as shown in FIG. 12 and FIG. 13, in the second peripheral region 103, the third region 10 further includes: a seventh sub-region 507 connected with the sixth sub-region 506. The seventh sub-region 507 connects the sixth sub-region 506 and the tenth sub-region 510.

The extension direction of the signal lines 201 in the seventh sub-region 507 intersects with the second direction Y, and the extension direction of the signal lines 201 in the seventh sub-region 507 intersects with the extension direction of the signal lines 201 in the sixth sub-region 506.

In the seventh sub-region 507, a plurality of first signal lines 2011 and a plurality of second signal lines 2012 are alternately arranged along the first direction X.

That is, in the second peripheral region, the signal line group extends in the second direction in the tenth sub-region. The extension direction of the signal line group is changed once in the seventh sub-region, and changed again in the sixth sub-region, and then returned to the second direction in the fifth sub-region, and the wiring of the signal line group is converted to overlapping wiring. In the specific implementation, how many times the extension direction needs to be changed between the tenth sub-region and the fifth sub-region, can be selected according to the number of signal lines and the actual wiring space of the signal line group.

It should be noted that FIG. 13 is a schematic diagram of the enlarged region D in FIG. 12.

In some embodiments, as shown in FIG. 12, the edge of the junction of the sixth sub-region 506 and the fifth sub-region 505 extends along the seventh direction X7. The angle a6 between the seventh direction X7 and the direction from the display region 101 to the first peripheral region 102-1 is greater than 0° and less than 90°.

The edge of the junction of the sixth sub-region 506 and the seventh sub-region 507 extends along the eighth direction X8. The angle a7 between the eighth direction X8 and the direction from the display region 101 to the first peripheral region 102-1 is greater than 0° and less than 90°.

In some embodiments, as shown in FIG. 12, the seventh direction X7 is parallel to the eighth direction X8. The angles a between the extension direction of parts of the signal lines 201 in the sixth sub-region 506 and the first direction X, the angle a6, and the angle a7 are all 45°.

In some embodiments, as shown in FIG. 12, the angle a9 between the extension direction of at least part of the signal lines 201 in the seventh sub-region 507 and the first direction X is greater than 0° and less than a8=45°.

In some embodiments, as shown in FIG. 12, the distance between the signal line 201 closest to the display region 101 of the fifth sub-region 505 to the display region 101 is L30. In the second direction Y, in the sixth sub-region 506, the distance from the junction b6 of the signal line 201 closest to the display region and the fifth sub-region 505 to the display region 101 is L31. In the sixth sub-region 506, the distance from the junction b7 of the signal line 201 closest to the display region and the seventh sub-region 507 to the junction b6 is L32. In the sixth sub-region 506, the distance from the junction b8 of the signal line 201 furthest from the display region and the fifth sub-region 505 to the display region 101 is L33. For example, L33 is greater than or equal to 680 μm, and less than or equal to 690 μm, L31 is about 200 μm, and L32 is about 230 μm. If the display substrate includes an electrostatic unit, L30 is greater than or equal to 92 μm, and L30 is preferably greater than 93 μm.

In some embodiments, as shown in FIG. 1, the display substrate includes two signal line groups 2, and the two signal line groups 2 correspond to two first peripheral regions 102-1 respectively.

In some embodiments, when the display substrate includes two signal line groups, one of the two signal line groups is electrically connected to an odd-numbered row of scanning lines, and the other one of the two signal line groups is electrically connected to an even-numbered row of scanning lines.

In some embodiments, as shown in FIG. 1, the display substrate also includes a ground level signal line 14 located on a side of the third signal line 8 away from the display region 101.

In the specific embodiment, as shown in FIG. 1, the ground level signal line 14 and the third signal line 8 are electrically connected with the bonding terminals (not shown) of the bonding region 1031. The display substrate further includes a third peripheral region 104 located on a side of the display region 101 away from the second peripheral region 103. The third signal line 8 leads from a side of the bonding region 1031 of the second peripheral region 103, extends to the first peripheral region 102-1, the third peripheral region 104. The first peripheral region 102-2 and then returns to the other side of the bonding region 1031 of the second peripheral region 103. The ground level signal line 14 leads out from one side of the bonding region 1031 of the second peripheral region 103, extends to the first peripheral region 102-1, the third peripheral region 104, the first peripheral region 102-2, and then returns to the other side of the bonding region 1031 of the second peripheral region 103.

Based on the same invention conception, some embodiments of the present disclosure also provides a display device, as shown in FIG. 14, and the display device includes:
the display substrate 15 provided in the embodiments of the disclosure;
the opposing substrate 16 arranged opposite to the display substrate 15;
a liquid crystal layer 17 positioned between the display substrate 15 and the opposing substrate 16.

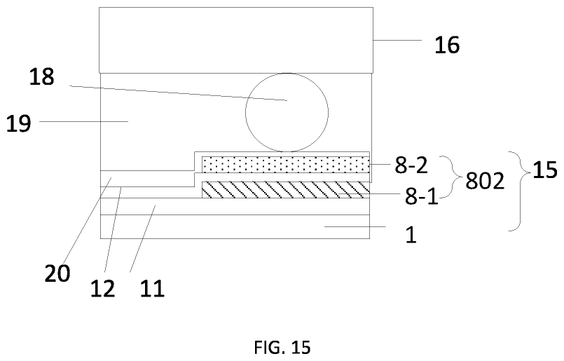

In some embodiments, as shown in FIG. 15, the display substrate includes a third signal line 8, and the third signal line 8 includes a second part 802.

The display panel also includes:
a plurality of support portions 18 between the display substrate 15 and the opposing substrate 16. The orthographic projection of the supporting portions on the first base substrate 1 overlaps with the orthographic projection of the second part 802 on the first base substrate 1.

In the specific embodiment, as shown in FIG. 15, the orthographic projection of at least part of the supporting portions 18 on the first base substrate 1 overlaps with the orthographic projections of the second sublayer 8-2 and the first sublayer 8-1 included in the second sublayer 802 on the first base substrate 1.

In the display device provided in the embodiment of the present disclosure, the orthographic projection of the supporting portions on the first base substrate and the orthographic projection of the second part on the first base substrate overlap with each other. Because the second part of the signal line adopts double-layer wiring, that is, the second part includes the first sublayer and the second sublayer, the thickness uniformity of the display substrate in the peripheral region is good, and the problem that the screen of the display device is yellowish due to the poor thickness uniformity of the display substrate corresponding to the supporting portions can be alleviated or even avoided, and the display effect is improved.

In the specific embodiment, as shown in FIG. 15, the encapsulant 19 including a plurality of support portions 18 is arranged between the substrate 15 and the opposing substrate 16. The support portions 18 are, for example, silicon balls included in the encapsulant 19.

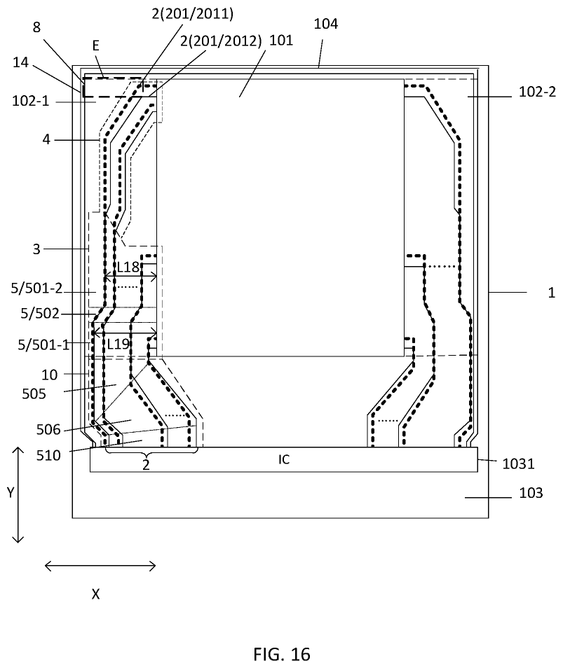

In some embodiments, as shown in FIG. 16, the display substrate includes a second peripheral region 103. The second peripheral region includes bonding region 1031. The display substrate further includes a plurality of signal terminals (not shown) located on a side of the first base substrate 1 in the bonding region 1031. The signal line group 2 is electrically connected with some of the plurality of signal terminals.

The display device also includes a driver chip IC. The driver IC is bonded to a plurality of signal terminals in the bonding region 1031.

In some embodiments, the opposing substrate includes: a second base substrate, a black matrix on a side of the second base substrate facing to the liquid crystal layer and color resists. The black matrix has open areas, which correspond to the sub-pixel units of the display substrate in a one-to-one manner. The color resists are located in the open areas. A spacer is located on a side of the black matrix facing to the liquid crystal layer. The color resists correspond to the sub-pixel regions in a one-to-one manner, and the orthographic projection of the color resists falls into the orthographic projection of the sub-pixel regions on the array substrate. The sub-pixel units include red sub-pixels, blue sub-pixels, and green sub-pixels. Correspondingly, the color resists include red color resists corresponding to the red sub-pixels, blue color resists corresponding to the blue sub-pixels, and green color resists corresponding to the green sub-pixels.

In some embodiments, the display apparatus provided in the present embodiment may also include a backlight module located on the light-entering side of the display substrate, and the backlight module may be a direct-entry backlight module or a side-entry backlight module.

In the specific implementation, the side-entry backlight module may include a light strip, a reflector arranged in layers, a light guide plate, a diffuser sheet, a prism group, etc., and the light bar is located on one side of the light guide plate in the thickness direction of the light guide plate. The direct-entry backlight module may include a matrix light source, a reflector stacked on the light-emitting side of the matrix light source, a diffusion plate and a brightness enhancement film, etc., and the reflector includes openings that are directly opposite to the position of each lamp bead in the matrix light source. The lamp beads in the light bar and the lamp beads in the matrix light source can be light-emitting diodes (LEDs), such as miniature light-emitting diodes (Mini LEDs, Micro LEDs, etc.). Micro light-emitting diodes (LEDs) in the sub-millimeter or even micron order are self-emitting devices like organic light-emitting diodes (OLEDs), and they have a series of advantages like organic light-emitting diodes have, such as high brightness, ultra-low latency, and ultra-large viewing angle. In addition, because inorganic light-emitting diodes emit light based on metal semiconductors with more stable properties and lower resistance, it has the advantages of lower power consumption, higher temperature and low temperature resistance, and longer service life than organic light-emitting diodes that emit light based on organic matter. In addition, when the micro light-emitting diodes are used as the backlight, they can achieve a more precise dynamic backlight effect, which can effectively improve the brightness and contrast of the screen, and also solve the glare phenomenon caused by the traditional dynamic backlight between the bright and dark areas of the screen, and optimize the visual experience.

The display device provided in the embodiment of the present disclosure is a mobile phone, a tablet computer, a television, a monitor, a laptop computer, a digital photo frame, a navigator and any other product or part with a display function. The other indispensable components of the display device are those reasonably skilled in the art and should be understood, and are not described herein and should not be used as a limitation on the present disclosure. The embodiment of the display device can be described in the embodiment of the above display panel, and the repetition will be omitted.

To sum up, in the display substrate, display panel and display device provided in the embodiments of the present disclosure, the orthographic projection of a plurality of first signal lines on the first base substrate and the orthographic projection of a plurality of second signal lines on the first base substrate overlap in the first region where the number of signal lines is large, that is, the plurality of signal lines included in the signal line group are overlapped and routed in the first region, so that the wiring space of the signal line can be saved, and the size of the first peripheral region in the first direction is avoided from being too large and is not conducive to realizing a narrow bezel. In the second region where the number of signal lines is small, a plurality of first signal lines and a plurality of second signal lines are alternately arranged along the second direction, that is, a plurality of first signal lines and a plurality of second signal lines included in a signal line group are alternately routed in the second region, and because the number of signal lines is reduced, a plurality of first signal lines and a plurality of second signal lines can be arranged alternately in the second region without increasing the width of the second peripheral region in the first direction, so as to avoid the complete overlap of signal lines and cause the capacitance to increase and affect the sub-pixel charging. Moreover, because the number of signal lines in the signal line group decreases in the second direction and in the direction that the first region points to the second region, the number of signal lines in the plurality of sub-regions included in the first region is not exactly the same, the number of signal lines included in at least one sub-region near the second region is less than the number of signal lines included in at least one sub-region far away from the second region, and the wiring space required for at least one sub-region near the second region is less than the wiring space required for at least one sub-region far away from the second region, thus, it can be set to the distance L18 between the edge of at least one sub-region away from the display region to the display region in at least one sub-region, is less than the distance L19 between the edge of at least one of the remaining sub-regions in the plurality of sub-regions far away from the display region and the display region, that is, one of the sub-regions retracts towards the display region relative to the other sub-region, and the wiring space on the side of the sub-region away from the display region increases, which is conducive to setting other structures.

Although preferred embodiments of the present disclosure have been described, those embodiments may be subject to additional changes and modifications once the basic inventive concepts are known to those skilled in the art. Therefore, the attached claims are intended to be construed to include the preferred embodiments and all changes and modifications that fall within the scope of the invention.

Obviously, a person skilled in the art may make various alterations and variations to the present disclosure without departing from the spirit and scope of the present disclosure. Thus, to the extent that such modifications and variants of the present disclosure fall within the scope of the claims of the present disclosure and its equivalents, the present disclosure is also intended to include such modifications and variants.

1. A display substrate, comprising:
a first base substrate comprising a display region and a peripheral region enclosing the display region; wherein the peripheral region comprises first peripheral regions that is respectively arranged on two sides of the display region in a first direction;
at least one signal line group, located at least in the first peripheral regions and disposed on a side of the first base substrate, wherein the at least one signal line group comprises a plurality of signal lines, and the plurality of signal lines comprise a plurality of first signal lines arranged along the first direction, and a plurality of second signal lines that are disposed in a layer different from a layer of the plurality of first signal lines and arranged along the first direction;
wherein in the first periphery area, the at least one signal line group comprises a first region and a second region arranged in an extension direction of the at least one signal line group; a quantity of signal lines comprised in the first region is greater than a quantity of signal lines comprised in the second region;
in the first region, an orthographic projection of the plurality of first signal lines on the first base substrate overlaps with an orthographic projection of the plurality of second signal lines on the first base substrate;
in the second region, the plurality of first signal lines and the plurality of second signal lines are alternately arranged along a first direction;
the first region comprises a plurality of sub-regions arranged sequentially in the extension direction of the at least one signal line group; and
a distance between an edge, far away from the display region, of at least one of the plurality of sub-regions and the display region is less than a distance between an edge, far away from the display region, of at least one of rest of the plurality of sub-regions and the display region.

2. The display substrate of claim 1, wherein the first region comprises: a plurality of first sub-regions and at least one second sub-region; the second sub-region connects two adjacent first sub-regions;
wherein in the first sub-regions, the signal lines extend along the second direction, and in the second sub-region, the signal lines extend along a third direction;
the second direction intersects with the first direction; and
an angle a1 between the third direction and a direction from a first peripheral region corresponding to the second sub-region to the display region is greater than 0° and less than 90°;
wherein the display substrate further comprises:
a plurality of scanning lines disposed on a side of the first base substrate, and extending from the display region to the first peripheral region; wherein the plurality of scanning lines are arranged along the second direction and extend along the first direction; one signal line in the at least one signal line group is electrically connected with one of the plurality of scanning lines at one end of the one signal line in an extension direction of the one signal line;
a quantity of signal lines comprised in the second sub-region is less a quantity signal lines comprised in a first sub-region that is connected with the second sub-region on a side far away from the second region;
wherein the quantity of signal lines comprised in the second sub-region is greater than or equal to a quantity of signal lines comprised in a first sub-region that is connected with the second sub-region on a side close to the second region;
wherein in the two first sub-regions connected by the second sub-region, a maximum width, in the first direction, of a first sub-region far away from the second region is greater than a maximum width, in the first direction, of a first sub-region close to the second region;
wherein in the two first sub-regions connected by the second sub-region, in the first sub-region far away from the second region, a first distance between a signal line closest to the display region at a junction of the first sub-region far away from the second region and the second sub-region, and the display region in the first direction is indicated as L1, and a second distance between a signal line closest to the display region at a junction of the first sub-region close to the second region and the second sub-region, and the display region in the first direction is indicated as L2;
a length of a signal line closest to the display region in the second sub-region in an extension direction of the signal line closest to the display region in the second sub-region is indicated as L3;
wherein L1, L2, and L3 satisfy:
$$L 2 < L 1 ; and$$
$$L 2 \geq L 1 - L 3 \times cos a 1 ;$$
wherein in the first sub-regions and the second sub-region, the signal line group comprises a plurality of subgroups, and at least part of the subgroups comprise one first signal line and one second signal line with an orthographic projection of the one first signal line on the first base substrate overlapping an orthographic projection of the one second signal line; in the first sub-regions and the second sub-region, line widths of the plurality of subgroups are equal, and spacings between any two adjacent subgroups are equal;
in the two first sub-regions connected with the second sub-region, the first sub-region far away from the second region comprises m subgroups, and the first sub-region close to the second region comprises n subgroups, wherein m>n, and m and n are positive integers;
the line widths L4 of the subgroups, the spacings L5 between the any two adjacent subgroups, the first distance L1, and the second distance L2 satisfy:
$$[ m \times L 4 + ( m - 1 ) \times L 5 ] - [ n \times L 4 + ( n - 1 ) \times L 5 ] \leq L 1 - L 2.$$

3-7. (canceled)

8. The display substrate of claim 2, wherein lengths of a plurality of signal lines comprised in the second sub-region in an extension direction of the plurality of signal lines comprised in the second sub-region are equal.

9. The display substrate of claim 8, wherein edges of junctions of the second sub-region and the two adjacent first sub-regions extend along a fourth direction, and an angle a2 between the fourth direction and a direction from the display region to the first peripheral region corresponding to the second sub-region is greater than 0° and less than 90°.

10. The display substrate of claim 9, wherein the angle a1 is greater than or equal to 30° and less than or equal to 60°, and the angle a2 is greater than or equal to 15° and less than or equal to 30°.

11. The display substrate of claim 2, wherein the first region comprises one second sub-region; the display region comprises a first edge extending along the first direction; an extension line of the first edge is positioned on a side of the first region far away from the second region;
in the second direction, a third distance from a junction of a signal line closest to the display region in the second sub-region and the first sub-region far away from the second region to the first edge is indicated as L7; the third distance L7 and a width L8 of the display region in the second direction satisfy: L7=L8/3;
or
wherein the first region comprises two second sub-regions; the display region comprises a first edge extending along the first direction; an extension line of the first edge is positioned on a side of the first region far away from the second region;
in the second direction, in a second sub-region of the two second sub-regions far away from the second region, a fourth distance from a junction of a signal line closest to the display region and a first sub-region far away from the second region to the first edge is indicated as L9; in the second direction, in a second sub-region of the two second sub-regions close to the second region, a fifth distance from a junction of a signal line closest to the display region and the first sub-region far away from the second region to the first edge is indicated as L10;
wherein the fourth distance L9 and the width L8 of the display region in the second direction satisfy: L9=L8/4; and
the fifth distance L10 and the width L8 of the display region in the second direction: L10=L8/2;
or
the display substrate further comprises:
a third signal line disposed on a side of the first base substrate and located in the peripheral region;
wherein in the first direction, the third signal line in the first peripheral region is located on a side of the signal line group far away from the display region;
the third signal line comprises a first part and a second part;
the second part is adjacent to at least the second sub-region and a first sub-region connected with the second sub-region on a side close to the second region;
in the first direction, a maximum width of the first part is less than a maximum width of the second part;
the second part comprises a first sublayer and a second sublayer on a side of the first sublayer facing away from the first base substrate; and
in the first periphery area, spacings between the second part and different sub-regions of the signal line group are approximately equal.

12-13. (canceled)

14. The display substrate of claim 11, wherein in a case of the second part comprising the first sublayer and the second sublayer, an orthographic projection of the second sublayer on the first base substrate is located within an orthographic projection of the first sublayer on the first base substrate;
or
wherein in a case of the second part comprising the first sublayer and the second sublayer, a pattern of an orthographic projection of the first sublayer on the first base substrate is grid-shaped;
or
wherein in a case of the second part comprising the first sublayer and the second sublayer, the first sublayer and the first signal lines are disposed in a same layer, and the second sublayer and the second signal lines are disposed in a same layer.

15-16. (canceled)

17. The display substrate of claim 2, wherein the first region further comprises a third sub-region, and the second region comprises a fourth sub-region connected with the third sub-region; the third sub-region is connected with a first sub-region closest to the second region;
signal lines in the fourth sub-region extend along the second direction, at least a part of signal lines in the third sub-region comprises a portion extending along a fifth direction, and an angle a3 between the fifth direction and a direction from the display region to the first peripheral region corresponding to the second sub-region is greater than 0° and less than 90°.

18. The display substrate of claim 17, wherein a quantity of signal lines comprised in the third sub-region is less than a quantity of signal lines comprised in the first sub-region closest to the second region;
wherein a quantity of signal lines comprised in the fourth sub-region is less than or equal to the quantity of signal lines comprised in the third sub-region;
wherein a minimum width of the first sub-region closest to the second region in the first direction is less than a maximum width of the fourth sub-region in the first direction;
wherein a signal line far away from the display region in the first sub-region connected with the third sub-region and a signal line far away from the display region in the fourth sub-region are is located on a same straight line;
wherein in the first direction, a sixth distance from a junction of a signal line closest to the display region in the first sub-region closest to the second region and the third sub-region to the display region is indicated as L11, a seventh distance from a signal line closest to the display region in the fourth sub-region to the display region is indicated as L12, and a length of the signal line closest to the display region in the third sub-region in an extension direction of the signal line closest to the display region in the third sub-region is indicated as L13;
wherein L11, L12, and L13 satisfy:
$$L 12 < L 11 ;$$
$$L 12 \geq L 11 - L 13 \times cos a 3 ;$$
wherein in the first sub-regions and the third sub-region, the signal line group comprises a plurality of subgroups;
wherein in the fourth sub-region, the first signal lines have a first line width L14, the second signal lines have a second line width L15, and a distance between the first signal lines and the second signal lines is indicated as L16,
wherein the first sub-region closest to the second region comprises k subgroups, and the fourth sub-region comprises e1 first signal lines and e2 second signal line; wherein e1, e2, k are positive integers, and e1+e2<2k;
wherein e1, e2, k, L11, L12, L14, L15, L16, the first line width L14, and a spacing L5 between adjacent subgroups satisfy:
$$[ e 1 \times L 14 + e 2 \times L 15 + ( e 1 + e 2 - 1 ) \times L 16 ] - [ k \times L 4 + ( k - 1 ) \times L 5 ] \leq L 11 - L 12.$$

19-22. (canceled)

23. The display substrate of claim 18, wherein in the first sub-regions and the third sub-region, the signal line group comprises a plurality of subgroups;
wherein in the fourth sub-region, the first signal lines have a first line width L14, the second signal lines have a second line width L15, and a distance between the first signal lines and the second signal lines is indicated as L16,
wherein the first sub-region closest to the second region comprises k subgroups, and the fourth sub-region comprises e1 first signal lines and e2 second signal line; wherein e1, e2, k are positive integers, and e1+e2<2k;
wherein e1, e2, k, L11, L12, L14, L15, L16, the line width L4 of the subgroups, and a spacing L5 between adjacent subgroups satisfy:
$$[ e 1 \times L 14 + e 2 \times L 15 + ( e 1 + e 2 - 1 ) \times L 16 ] - [ k \times L 4 + ( k - 1 ) \times L 5 ] \leq L 11 - L 12.$$

24. The display substrate of claim 23, wherein the first region comprises one second sub-region; the display region comprises a first edge extending along the first direction; an extension line of the first edge is positioned on a side of the first region far away from the second region;
wherein in the second direction, an eighth distance from a junction of a signal line closest to the display region in the third sub-region and the first sub-region to the first edge is indicated as L17; and
the eighth distance L17 and a width L8 of the display region in the second direction satisfy: L17=2×L8/3;
or
wherein the first region comprises two second sub-regions; the display region comprises a first edge extending along the first direction; an extension line of the first edge is positioned on a side of the first region far away from the second region;
wherein in the second direction, an eighth distance from a junction of a signal line closest to the display region in the third sub-region and the first sub-region to the first edge is indicated as L17; the eighth distance L17 and a width L8 of the display region in the second direction satisfy: L17=3×L8/4.

25. (canceled)

26. The display substrate of claim 18, wherein in a direction from the first peripheral region corresponding to the third sub-region to the display region;
a length, in an extension direction of the plurality of first signal lines, of the plurality of first signal lines comprised in the third sub-region gradually increases; and
a length, in an extension direction of the plurality of second signal lines, of the plurality of second signal lines comprised in the third sub-region gradually increases.

27. The display substrate of claim 26, wherein an edge of a junction of the third sub-region and the first sub-region extends along the fifth direction, and an angle a4 between the fifth direction and a direction from the display region to the first peripheral region corresponding to the second sub-region is greater than 0° and less than 90°; and
an edge of a junction of the third sub-region and the fourth sub-region extends along a sixth direction, and an angle a5 between the sixth direction and a direction from the first peripheral region corresponding to the second sub-region to the display region is greater than 0° and less than 90°;
wherein the angle a3 is greater than or equal to 30° and less than or equal to 60°;
the angle a4 is greater than or equal to 15° and less than or equal to 30°; and
the angle a5 is greater than or equal to 5° and less than or equal to 15°.

28. (canceled)

29. The display substrate of claim 18, further comprising a third signal line, and the third signal line comprises a second part; the second part is adjacent to the third sub-region and the fourth sub-region.

30. The display substrate of claim 2, wherein the peripheral region further comprises a second peripheral region on a side of the display region in the second direction;
wherein the signal line group further comprises a fifth sub-region and a sixth sub-region in the second peripheral region;
wherein the fifth sub-region connects the sixth sub-region with the first region, signal lines in the fifth sub-region extend along the second direction, and an extension direction of signal lines in the sixth sub-region intersects with the second direction;
wherein in the fifth sub-region, the orthographic projection of the plurality of first signal lines on the first base substrate overlaps with the orthotropic projection of the plurality of second signal lines on the first base substrate; and
in the sixth sub-region, the plurality of first signal lines and the plurality of second signal lines are alternately arranged along the first direction.

31. The display substrate of claim 30, wherein the signal line group in the second peripheral region further comprises a seventh sub-region connected with the sixth sub-region;
wherein an extension direction of signal lines in the seventh sub-region intersects with the second direction, and the extension direction of the signal lines in the seventh sub-region intersects with the extension direction of the signal lines in the sixth sub-region;
wherein in the seventh sub-region, the plurality of first signal lines and the plurality of second signal lines are alternately arranged along the first direction;
wherein an edge of a junction of the sixth sub-region and the fifth sub-region extends along a seventh direction, and an angle a6 between the seventh direction and a direction from the display region to the first peripheral region is greater than 0° and less than 90;
wherein an edge of a junction of the sixth sub-region and the seventh sub-region extends along an eighth direction, and an angle a7 between the eighth direction and the direction from the display region to the first peripheral region is greater than 0° and less than 90°;
wherein the seventh direction is parallel to the eighth direction; and
an angle a8 between an extension direction of at least part of the signal lines in the sixth sub-region and the first direction, the angles a6, and the angle a7 are all 45°.

32-33. (canceled)

34. The display substrate of claim 2, wherein the display substrate comprises two signal line groups, and the two signal line groups correspond to two first peripheral regions respectively; and
the display substrate comprises a plurality of scanning lines, one of the two signal line groups is electrically connected with scanning lines in odd-numbered rows, and other group of the two signal line groups is electrically connected with scanning lines in even-numbered rows.

35. A display device, comprising:
the display substrate of claim 1;
an opposing substrate arranged oppositely to the display substrate, and
a liquid crystal layer between the display substrate and the opposing substrate.

36. The display device of claim 35, wherein the display substrate comprises a third signal line, and the third signal line comprises a second part;
wherein display device further comprises:
a plurality of supporting portions between the display substrate and the opposing substrate;
wherein an orthographic projection of the supporting portions on the first base substrate overlaps with an orthographic projection of the second part on the first base substrate.

37. The display device of claim 35, wherein the display substrate comprises a second peripheral region, and the second periphery region comprises a bonding region;
the display substrate further comprises a plurality of signal terminals disposed on a side of the first base substrate and located in the bonding region, and the signal line group is electrically connected with a part of the plurality of signal terminals;
wherein the display device further comprises a driver chip, and the driver chip is bonded to the plurality of signal terminals in the bonding region.
